(19) United States
(12) Patent Application Publication
(10) Pub. No.: US 2020/0270460 A1
(43) Pub. Date: Aug. 27, 2020

(54) MIXTURES OF FIBRE-REACTIVE AZO DYES, THEIR PREPARATION AND THEIR USE

(71) Applicant: Archroma IP GmbH, Reinach (CH)

(72) Inventors: Asad Bilal Haleem, Bahawalpur (PK); Shahid Ali Ahmed, Karachi (PK); Rainer Nusser, Neuenburg Am Rhein (DE)

(21) Appl. No.: 16/650,208

(22) PCT Filed: Oct. 12, 2018
(86) PCT No.: PCT/EP2018/077865

§ 371 Date: Mar. 24, 2020

(30) Foreign Application Priority Data
Oct. 13, 2017 (PK) 534/2017
Dec. 7, 2017 (EP) 17206018.8

(51) Int. Cl. C09B 67/22; D06P 1/38; D06P 5/30

(52) U.S. Cl. CPC C09B 67/0058; D06P 5/30; D06P 1/38; C09B 67/0059

(57) ABSTRACT

The present invention relates to novel mixtures of reactive dyes, a composition comprising the dye mixture according to the invention, an ink or a printing ink or printing paste or dyeing bath for printing or dyeing a substrate comprising the dye mixture according to the invention or the composition according to the invention, their use for dyeing and/or printing substrates, a process for dyeing or printing substrates and substrates comprising the dye mixture according to the invention or the composition according to the invention. Those mixtures are suitable for dyeing and/or printing substrates, such as paper, textiles, glass, plastics or metal, and can be applied in combination with other dyes.

### FIELD OF THE INVENTION

The present invention relates to novel mixtures of reactive dyes, a composition comprising the dye mixture according to the invention, an ink or a printing ink or printing paste or dyeing bath for printing or dyeing a substrate comprising the dye mixture according to the invention or the composition according to the invention, their use for dyeing and/or printing substrates, a process for dyeing or printing substrates with the dye mixture according to the invention or the composition according to the invention and substrates comprising the dye mixture according to the invention or the composition according to the invention.

### BACKGROUND OF THE INVENTION

Reactive dyes (also referred to as “fiber-reactive azo dyes”) are known in the art. Reactive dyes are a class of organic substances dyes that contain at least one substituent which reacts with the substrate and thus forms a covalent bond between the molecule of the dye and the substrate to be colored.

For example, WO 2007/039573 A2 relates to azo reactive dyes and mixtures of fiber-reactive azo dyes, to processes for their preparation and to their use for dyeing and printing hydroxyl- and carboxamido-containing materials.

Furthermore WO 2004/088031 also relates to azo reactive dyes and mixtures of fiber reactive dyes, their preparation and their use.

WO 2015/149940 relates to compounds that are obtained by coupling two aminoaryl compounds in diazotized form onto 3-aminophenlyurea. These compounds are used as azo reactive dyes in dyeing and printing processes.

However, there is still a need for novel dyes, in particular fiber-reactive dyes, with good properties such as dye levelness (i.e. the uniformity of color shade along the substrate to be dyed), color fastness (light and wet/washing fastness, i.e. the resistance of the color to fading and running when exposed to light and/or wetness) and build-up behavior.

### OBJECT OF THE INVENTION

It is an object of the present invention to provide novel dye mixtures comprising fiber-reactive dyes with good dyeing characteristics, such as levelness, light and wet/washing fastnesses and build-up behavior which are highly suitable for dyeing and/or printing substrates, such as paper, textiles, glass, plastics or metal, and can be applied in combination with other dyes.

### SUMMARY OF THE INVENTION

The object can be achieved with a dye mixture according to the invention comprising at least one compound of the general formula (I) or a salt thereof and at least one compound of the general formula (II) or a salt thereof and optionally at least one compound of the general formula (III) or a salt thereof.

It has been surprisingly found that dye mixtures according to the invention have good dyeing characteristics, such as levelness, light and wet/washing fastnesses and build-up behavior, compared to the dyes or the dye mixtures known in the prior art.

The improvement of the dye mixture of the present invention is particularly achieved during dyeing and printing processes, such as inkjet printing.

In a first aspect, the invention relates to a dye mixture comprising or consisting of at least one compound of the general formula (I) or a salt thereof

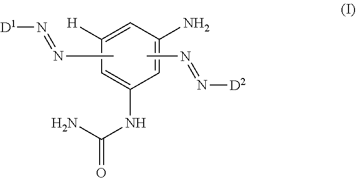

wherein
D¹ and D² are independently from each other unsubstituted or substituted aryl, and
at least one compound of the general formula (II) or a salt thereof

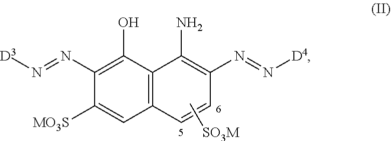

wherein
M is independently selected from —H, an alkali metal cation, an alkaline earth metal cation, an organic ammonium cation or a mixture thereof,
and optionally at least one compound of the general formula (III) or a salt thereof

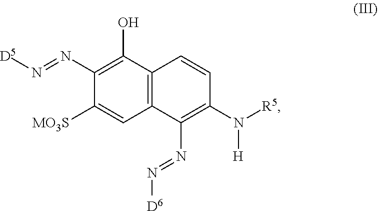

wherein
M is independently selected from —H, an alkali metal cation, an alkaline earth metal cation, an organic ammonium cation or a mixture thereof, and wherein M as defined in formula (III) is identical or different to M as defined in formula (II),
R⁵ is —H or unsubstituted or substituted, linear or branched C₁₋₈ alkyl,
D³, D⁴, D⁵ and D⁶ are independently from each other a residue of the general formula (IV) or a salt thereof

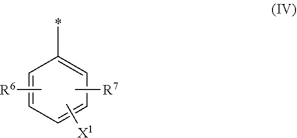

wherein
R⁶ and R⁷ are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein M is independently selected from —H, an alkali metal cation, an alkaline earth metal cation, an organic ammonium cation or a mixture thereof and wherein M as defined in formula (IV) is identical or different to M as defined in formula (II) or (III),
X¹ is —H or a radical of the general formula —SO₂Y¹, wherein
Y¹ is —OH, —CH═CH₂ or —CH₂CH₂—Z, wherein
Z is —OH or a leaving group which can be eliminated under the action of alkali,
* signifies the attachment to the azo group of formula (II) and/or (III)
and/or
D³, D⁴, D⁵ and D⁶ are independently from each other a residue of the general formula (V) or a salt thereof

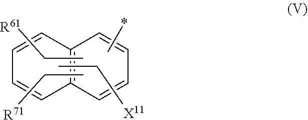

R⁶¹ and R⁷¹ are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein M is independently selected from —H, an alkali metal cation, an alkaline earth metal cation, an organic ammonium cation or a mixture thereof, and wherein M as defined in formula (V) is identical or different to M as defined in formula (II), (III) or (IV),
X¹¹ is —H or a radical of the general formula —SO₂Y¹, wherein
Y¹ is —OH, —CH═CH₂ or —CH₂CH₂—Z, wherein
Z is —OH or a leaving group which can be eliminated under the action of alkali;
* signifies the attachment to the azo group of formula (II) and/or (III)
and/or
D³, D⁴, D⁵ and D⁶ are independently from each other a residue of the general formula (VI) or a salt thereof

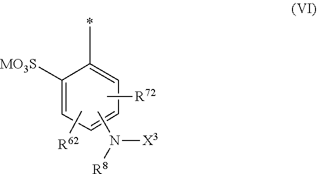

R⁶² and R⁷² are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein M is independently selected from —H, an alkali metal cation, an alkaline earth metal cation, an organic ammonium cation or a mixture thereof, and wherein M as defined in formula (VI) is identical or different to M as defined in formula (II), (III), (IV) or (V),
R⁸ is —H, unsubstituted or substituted, linear or branched C₁₋₆ alkyl or unsubstituted phenyl or substituted phenyl; and
* signifies the attachment to the azo group of formula (II) and/or (III)
X³ is a radical of the general formula (VII), (VIII) or (IX)

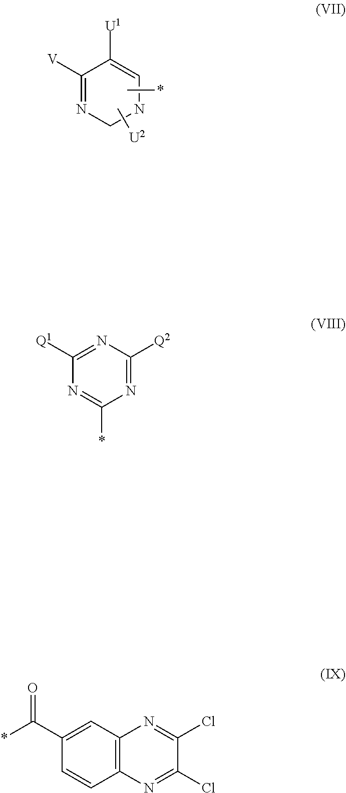

wherein
* signifies the attachment to the amino group of formula (VI)
V is —F or —Cl;
U¹ and U² are independently from each other —F, —Cl or —H;
Q¹ and Q² are independently from each other —F, —Cl, —NHCN, —OH, unsubstituted or substituted, linear or branched C₁₋₆ alkoxy, phenoxy, mercapto, unsubstituted or substituted, linear or branched C₁₋₆ alkylmercapto, pyridine, carboxypyridino, carbamoylpyridino or a radical of the general formula (X) or (XI)

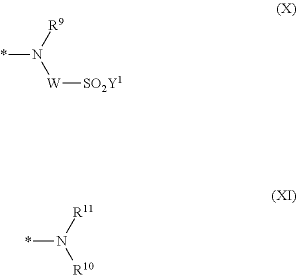

wherein
* signifies the attachment to formula (VIII),
R⁹ is —H, unsubstituted or substituted, linear or branched C₁₋₆ alkyl, linear or branched sulfo-(C₁₋₆)-alkyl or unsubstituted phenyl or substituted phenyl,
R¹⁰ and R¹¹ are independently from each other R⁹ or form together a cyclic ring of the formula —(CH₂)ₙ— with n being 4 or 5 or —(CH₂)₂-E-(CH₂)₂—, wherein E is O, S, SO₂ or NR¹² and R¹² is unsubstituted or substituted, linear or branched C₁₋₆ alkyl,
W is unsubstituted or substituted phenylen, C₁₋₄-alkylene-arylene, C₂₋₆ alkylene, C₂₋₆ alkylene being interrupted by —O—, —S—, —SO₂—, —NH—, —CO— and —C(O)NH—; unsubstituted or substituted phenylene-C(O)NH-phenylene or unsubstituted or substituted naphthylene,
Y¹ is —OH, —CH═CH₂ or —CH₂CH₂—Z, wherein
Z is —OH or a leaving group which can be eliminated under the action of alkali.

In a second aspect, the invention relates to a composition comprising the dye mixture according to the invention.

In a third aspect, the invention relates to an ink or printing ink or inkjet printing ink or printing paste or dyeing bath for printing or dyeing a substrate comprising the dye mixture according to the invention or the composition according to the invention.

In a fourth aspect, the invention relates to the use of the dye mixture according to the invention or the composition according to the invention for dyeing and printing substrates.

In a fifth aspect, the invention relates to a process for dyeing or printing substrates with the dye mixture according to the invention or a composition according to the invention.

In a sixth aspect, the invention relates to a substrate comprising the dye mixture according to the invention or the composition according to the invention.

### DETAILED DESCRIPTION OF THE INVENTION

In a first aspect the invention provides a dye mixture comprising or consisting of at least one compound of the general formula (I) or a salt thereof

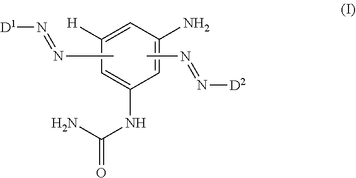

wherein
D¹ and D² are independently from each other unsubstituted or substituted aryl, and
at least one compound of the general formula (II) or a salt thereof

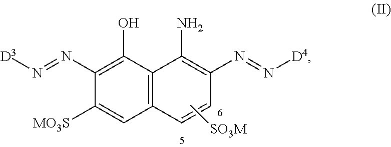

wherein
M is independently selected from —H, an alkali metal cation, an alkaline earth metal cation, an organic ammonium cation or a mixture thereof,
and optionally at least one compound of the general formula (III) or a salt thereof

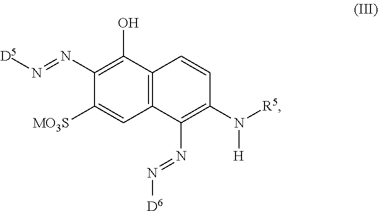

wherein
M is independently selected from —H, an alkali metal cation, an alkaline earth metal cation, an organic ammonium cation or a mixture thereof, and wherein M as defined in formula (III) is identical or different to M as defined in formula (II),
R⁵ is —H or unsubstituted or substituted, linear or branched C₁₋₈ alkyl,
D³, D⁴, D⁵ and D⁶ are independently from each other a residue of the general formula (IV) or a salt thereof

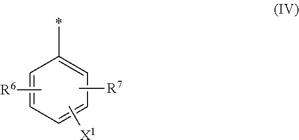

wherein
R⁶ and R⁷ are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein M is independently selected from —H, an alkali metal cation, an alkaline earth metal cation, an organic ammonium cation or a mixture thereof and wherein M as defined in formula (IV) is identical or different to M as defined in formula (II) or (III),
X¹ is —H or a radical of the general formula —SO₂Y¹, wherein
Y¹ is —OH, —CH═CH₂ or —CH₂CH₂—Z, wherein
Z is —OH or a leaving group which can be eliminated under the action of alkali,
* signifies the attachment to the azo group of formula (II) and/or (III)
and/or
D³, D⁴, D⁵ and D⁶ are independently from each other a residue of the general formula (V) or a salt thereof

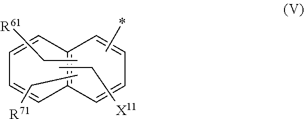

R⁶¹ and R⁷¹ are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein M is independently selected from —H, an alkali metal cation, an alkaline earth metal cation, an organic ammonium cation or a mixture thereof, and wherein M as defined in formula (V) is identical or different to M as defined in formula (II), (III) or (IV),
X¹¹ is —H or a radical of the general formula —SO₂Y¹, wherein
Y¹ is —OH, —CH═CH₂ or —CH₂CH₂—Z, wherein
Z is —OH or a leaving group which can be eliminated under the action of alkali,
* signifies the attachment to the azo group of formula (II) and/or (III)
and/or
D³, D⁴, D⁵ and D⁶ are independently from each other a residue of the general formula (VI) or a salt thereof

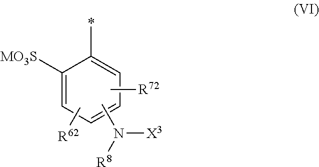

R⁶² and R⁷² are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein wherein M is independently selected from —H, an alkali metal cation, an alkaline earth metal cation, an organic ammonium cation or a mixture thereof, and wherein M as defined in formula (VI) is identical or different to M as defined in formula (II), (III), (IV) or (V),
R⁸ is —H, unsubstituted or substituted, linear or branched C₁₋₆ alkyl or unsubstituted phenyl or substituted phenyl,
* signifies the attachment to the azo group of formula (II) and/or (III)
X³ is a radical of the general formula (VII), (VIII) or (IX)

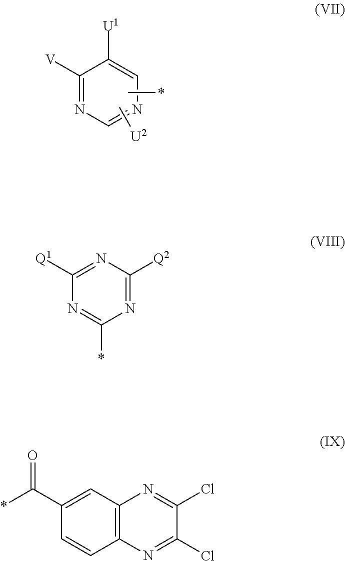

wherein
* signifies the attachment to the amino group of formula (VI),
V is —F or —Cl;
U¹ and U² are independently from each other —F, —Cl or —H;
Q¹ and Q² are independently from each other —F, —Cl, —NHCN, —OH, unsubstituted or substituted, linear or branched C₁₋₆ alkoxy, phenoxy, mercapto, unsubstituted or substituted, linear or branched C₁₋₆ alkylmercapto, pyridine, carboxypyridino, carbamoylpyridino or a radical of the general formula (X) or (XI):

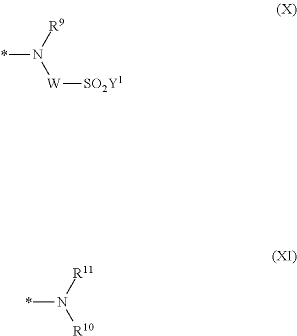

wherein
* signifies the attachment to formula (VIII)
R⁹ is —H, unsubstituted or substituted, linear or branched C₁₋₆ alkyl, linear or branched sulfo-(C₁₋₆)-alkyl or unsubstituted phenyl or substituted phenyl,
R¹⁰ and R¹¹ are independently from each other R⁹ or form together a cyclic ring of the formula —(CH₂)ₙ— with n being 4 or 5 or —(CH₂)₂-E-(CH₂)₂—, wherein E is O, S, SO₂ or NR¹² and R¹² is unsubstituted or substituted, linear or branched C₁₋₆ alkyl,
W is unsubstituted or substituted phenylen, C₁₋₄-alkylene-arylene, C₂₋₆ alkylene; C₂₋₆ alkylene being interrupted by —O—, —S—, —SO₂—, —NH—, —CO— and —C(O)NH—; unsubstituted or substituted phenylene-C(O)NH-phenylene, unsubstituted or substituted naphthylene,
Y¹ is —OH, —CH═CH₂ or —CH₂CH₂—Z, wherein
Z is —OH or a leaving group which can be eliminated under the action of alkali.

The term “dye mixture” within the context of the present application encompasses any combination of at least one compound of general formula (I) or a salt thereof, at least one compound of general formula (II) or a salt thereof and optionally at least one compound of general formula (III) or a salt thereof. In a preferred embodiment, the term dye mixture within the context of the present application means a homogenous mixture of at least one compound of general formula (I) or a salt thereof, at least one compound of general formula (II) or a salt thereof and optionally at least one compound of general formula (III) or a salt thereof.

Any of the compounds of general formulae (I), (II) and (III) used in the dye mixture according to the invention might carry negative charges stemming e.g. from acid groups, like CO₂⁻ or SO₃⁻ which might be present in the compounds of general formulae (I), (II) and (III), respectively the residues of formula (IV), (V), or (VI) contained in the compounds of general formulae (I), (II) or (III). The anionic charge(s) is(are) balanced by cation(s) “M”. Thus e.g. the expression “—SO₃M” within the context of the present application signifies —SO₃⁻ and M⁺.

M is selected from —H, an alkali metal cation, an alkaline earth metal cation, an organic ammonium cation. If more than one cation M is present in the respective formula, then the cations can be identical e.g. all M signify sodium, or also mixtures of H, an alkali metal cation, an alkaline earth metal cation, an organic ammonium cation can be present, e.g. one M signifies sodium and another M signifies H.

If the negative charge is only balanced by hydrogen, i.e. all M signify H, the “free-acid form” is obtained.

If the compounds of formulae (I), (II) or (III) are in salt-form, the cation(s) associated with the anionic groups is (are) not critical and may be any of those non-chromophoric cations conventional in the field of dyestuffs, in particular fiber-reactive dyestuffs provided that the corresponding salt is substantially water-soluble. Examples of those cations are alkali metal cations, for example potassium, lithium or sodium, alkaline earth metal cations for example magnesium or calcium or organic ammonium cations, e.g. mono-, di-, tri- and tetramethyl or mono-, di-, tri- and tetraethyl ammonium cations. The cations M may be the same or different, i. e. the compound may be in mixed salt-form or in form of a mixture of the free-acid and the salt-form.

The term “alkali metal cation” within the context of the present application encompasses the cations of group 1 elements of the periodic table except for hydrogen, i.e. Li, Na, K, Rb, Cs and Fr. In a preferred embodiment of the present application, the term alkali metal cation encompasses the cations of Li, Na, K and Rb, particularly the cations of Li, Na and K.

The term “alkaline earth metal cation” within the context of the present application encompasses the cations of group 2 elements of the periodic table, i.e. Be, Mg, Ca, Sr, Ba and Ra. In a preferred embodiment of the present application, the term alkaline earth metal cation encompasses the cations of Mg, Ca, Sr and Ba, particularly the cations of Mg and Ca.

The term “organic ammonium cation” within the context of the present application encompasses a positively charged nitrogen atom carrying four residues in total, wherein at least one is an alkyl residue having 1 to 10 carbon atoms and the remaining residues might be hydrogen or alkyl residue having 1 to 10 carbon atoms.

Depending on the reaction and/or isolation conditions, the compound of formulae (I), (II) or (III) as used in the dye mixture according to the invention may be obtained as a free acid or in the salt-form or in the mixed salt-form, containing for example at least one of the above-mentioned cations. The compound of formulae (I), (II) or (III) may be converted from the salt-form or mixed salt-form to the free-acid form or vice versa using conventional techniques.

Further, if more than one cation M is present in more than one compound of general formulae (I), (II), or (III), respectively more than one residue of formula (IV), (V), or (VI) the cations of these compounds, respectively residues can be identical or can be different from each other. E.g. the compound of formula (I) can be present in the dye mixture as sodium salt (M=Na) and the compound of formula (II) can be present as potassium salt (M=K).

As used within the context of the present application, the term “compound” encompasses any single compound or any mixture of two or more compounds of formula (I), formula (II) and formula (III) as defined herein, respectively. Thus, the term “compound” also encompasses mixtures of two or more compounds of formula (I), formula (II) or formula (III) which are different with respect to their chemical structure and/or with regard to their stereochemical structure.

In one embodiment, the dye mixture according to the invention comprises or consists of the following components (a), (b) and (c), wherein
(a) is from 1 to 60 parts of at least one compound of formula (I) or a salt thereof,
(b) is from 20 to 99 parts of at least one compound of formula (II) or a salt thereof, and
(c) is from 0.0 to 60 parts of at least one compound of formula (III) or a salt thereof,
wherein all parts are by weight and the number of parts of components (a), (b) and (c) amounts to 100.

Preferably, the number of parts of component (a) is from 5 to 55, or from 10 to 45, or from 15 to 40, or from 30 to 40. The number of parts of component (b) is from 30 to 90 or from 40 to 80, or from 50 to 75. The number of parts of component (c) is from 0.0 to 40, or from 0.0 to 30, or from 0.0 to 20.

In one embodiment, the dye mixture according to the invention comprises or consists of at least one compound of formula (I) or a salt thereof, at least one compound of formula (II) or a salt thereof and at least one compound of formula (III) or a salt thereof.

In a preferred embodiment, the number of parts of component (a) is from 5 to 55, or from 10 to 45, or from 15 to 40, or from 30 to 40. The number of parts of component (b) is from 30 to 90 or from 40 to 80, or from 50 to 75. The number of parts of component (c) is from 0.1 to 40, or from 0.1 to 30, or from 0.1 to 20.

In one embodiment, the dye mixture according to the invention consists of at least one compound of formula (I) or a salt thereof, at least one compound of formula (II) or a salt thereof and optionally of at least one compound of formula (III) or a salt thereof.

In one preferred embodiment, the dye mixture according to the invention consists of the following components (a), (b) and (c), wherein:
(a) is from 1 to 60 parts of at least one compound of formula (I) or a salt thereof,
(b) is from 20 to 99 parts of at least one compound of formula (II) or a salt thereof, and
(c) is from 0.0 to 60 parts of at least one compound of formula (III) or a salt thereof,
   wherein all parts are by weight and the number of parts of components (a), (b) and (c) amounts to 100.

Preferably, the number of parts of component (a) is from 5 to 55, or from 10 to 45, or from 15 to 40, or from 30 to 40. The number of parts of component (b) is from 30 to 90 or from 40 to 80, or from 50 to 75. The number of parts of component (c) is from 0.0 to 40, or from 0.0 to 30, or from 0.0 to 20.

In another embodiment, the dye mixture of the invention consists of at least one compound of formula (I) or a salt thereof, at least one compound of formula (II) or a salt thereof and at least one compound of formula (III) or a salt thereof.

In another preferred embodiment the dye mixture according to the invention consists of the following components (a), (b) and (c), wherein
(a) is from 1 to 60 parts of at least one compound of formula (I) or a salt thereof,
(b) is from 20 to 99 parts of at least one compound of formula (II) or a salt thereof, and
(c) is from 0.1 to 60 parts of at least one compound of formula (III) or a salt thereof,
   wherein all parts are by weight and the number of parts of components (a), (b) and (c) amounts to 100.

In a preferred embodiment, the number of parts of component (a) is from 5 to 55, or from 10 to 45, or from 15 to 40, or from 30 to 40. The number of parts of component (b) is from 30 to 90 or from 40 to 80, or from 50 to 75. The number of parts of component (c) is from 0.1 to 40, or from 0.1 to 30, or from 0.1 to 20.

### Compound of General Formula (I)

The dye mixture according to the invention comprises at least one compound of the general formula (I) or a salt thereof

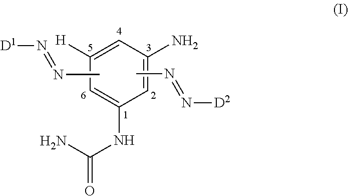

wherein
D¹ and D² are independently from each other unsubstituted or substituted aryl.

The compound of the general formula (I) represents an aminophenylurea onto which two aminoaryl compounds in diazotized form have been coupled. The synthesis of compounds of general formula (I) is described in detail in WO 2015/149940 A1. The numbers at the phenyl ring presented in the above formula will be used to describe the substitution pattern.

The term “aryl” within the context of the present application denotes a monocyclic or polycyclic residue derived from an aromatic hydrocarbon. The aryl residue might be unsubstituted denoting in the context of the present application that the aromatic hydrocarbon residue carries only hydrogen atoms. The aryl residue might be substituted denoting in the context of the present application that the aromatic hydrocarbon residue is substituted with heteroatoms others than hydrogen.

The term “phenyl” within the context of the present application denotes an aromatic residue derived from benzene C₆H₆. The phenyl residue might be unsubstituted denoting in the context of the present application that the aromatic hydrocarbon residue carries only hydrogen atoms, i.e. a residue of formula C₆H₅. The phenyl residue might be substituted denoting in the context of the present application that the aromatic hydrocarbon residue is substituted with heteroatoms others than hydrogen.

The term “naphthylene” within the context of the present application denotes an aromatic residue derived from naphthalene, i.e. a compound consisting of two condensed benzene rings having formula C₁₀H₈. The naphthylene residue might be unsubstituted denoting in the context of the present application that the aromatic hydrocarbon residue carries only hydrogen atoms, i.e. a residue of formula C₁₀H₇. The naphthylene residue might be substituted denoting in the context of the present application that the aromatic hydrocarbon residue is substituted with heteroatoms others than hydrogen.

The substituents of the substituted aryl are selected from the group of —H, —SO₃M, unsubstituted or substituted, linear or branched C₁₋₆ alkyl, unsubstituted or substituted, linear or branched C₁₋₆ alkoxy or SO₂Y, wherein Y is —OH, —CH═CH₂ or —CH₂CH₂—Z, wherein Z is —OH or a leaving group which can be eliminated under the action of alkali and M is independently selected from —H, an alkali metal cation, an alkaline earth metal cation, an organic ammonium cation or a mixture thereof.

In one preferred embodiment M is selected from alkali metal cation, preferably Na. In another preferred embodiment M is selected from organic ammonium cation, preferably a mono-, di-, tri- or tetramethyl ammonium cation or a mono-, di-, tri- or tetraethyl ammonium cation or a mixture thereof.

The substituents of the substituted alkyl and alkoxy groups are selected from the group consisting of halogen, —CN, —NH₂ or —COOM, wherein M is independently selected from —H, an alkali metal cation, an alkaline earth metal cation, an organic ammonium cation or a mixture thereof.

Within the context of the present application the term “leaving group that can be eliminated under the action of alkali” denotes each group that is eliminated once the compound exposed to alkali conditions, i.e. particularly the exposure to OH⁻ ions.

In particular, it signifies a leaving group that is selected from the group consisting of halides, phosphate esters, sulfate esters and tertiary amines, preferably halides and sulfate esters. Preferably Z is —Cl or —OSO₃M. M is independently selected from —H, an alkali metal cation, an alkaline earth metal cation, an organic ammonium cation or a mixture thereof, but hydrogen is preferred.

In one embodiment,
D¹ is

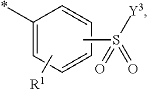

and
D² is

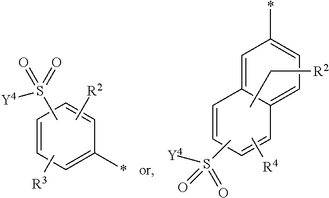

R¹ and R² are independently from each other —H, —SO₃M, unsubstituted or substituted, linear or branched C₁₋₆ alkyl or unsubstituted or substituted, linear or branched C₁₋₆ alkoxy,
R³ is —H, unsubstituted or substituted, linear or branched C₁₋₆ alkyl or unsubstituted or substituted, linear or branched C₁₋₆ alkoxy,
R⁴ is —H or —SO₃M, wherein
M is independently selected from —H, an alkali metal cation, an alkaline earth metal cation, an organic ammonium cation or a mixture thereof, preferably from an alkali metal cation, an organic ammonium cation or a mixture thereof,
Y³ and Y⁴ are independently from each other —OH, —CH═CH₂ or —CH₂CH₂—Z, wherein Z is —OH or a leaving group which can be eliminated under the action of alkali, and
* signifies the attachment to the azo group of formula (I).

It is possible that either Y³ or Y⁴ is —OH.
In a further embodiment
D¹ is

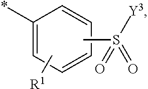

and
D² is

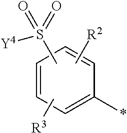

R¹ and R² are independently from each other —H, —SO₃M, unsubstituted or substituted C₁₋₂ alkyl or unsubstituted or substituted C₁₋₂ alkoxy,
M is independently selected from —H, an alkali metal cation, an alkaline earth metal cation, an organic ammonium cation or a mixture thereof, preferably from an alkali metal cation or an organic ammonium cation,
R³ is —H, methyl or methoxy,
Y³ and Y⁴ are independently from each other —OH, —CH═CH₂ or —CH₂CH₂—Z, wherein Z is —Cl or —OSO₃H, and
* signifies the attachment to the azo group of formula (I).

In a further embodiment
D¹ is

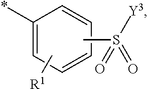

and
D² is

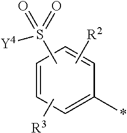

R¹ and R² are independently from each other —H, —SO₃M, unsubstituted or substituted C₁₋₂ alkyl or unsubstituted or substituted C₁₋₂ alkoxy,
M is independently selected from —H, an alkali metal cation, an alkaline earth metal cation, an organic ammonium cation or a mixture thereof, preferably from an alkali metal cation or an organic ammonium cation or a mixture thereof,
R³ is H,
Y³ and Y⁴ are independently from each other —OH, —CH═CH₂ or —CH₂CH₂—Z, wherein Z is —Cl or —OSO₃H, and
* signifies the attachment to the azo group of formula (I).

In a further embodiment
D¹ is

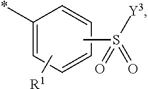

and
D² is

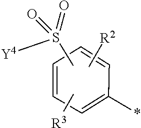

R¹ and R² are independently from each other —H, —SO₃M, unsubstituted or substituted C₁₋₂ alkyl or unsubstituted or substituted C₁₋₂ alkoxy,
M is independently selected from —H, an alkali metal cation, an alkaline earth metal cation, an organic ammonium cation or a mixture thereof, preferably from an alkali metal cation, an organic ammonium cation or a mixture thereof,
R³ is H,
Y³ and Y⁴ are independently from each other —OH, —CH═CH₂ or —CH₂CH₂—Z, wherein Z is —Cl or —OSO₃H, and
* signifies the attachment to the azo group of formula (I),
wherein the SO₂Y³ group is in para-position or in meta-position to the azo group.

In a further embodiment
D¹ is

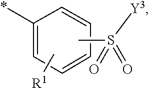

and
D² is

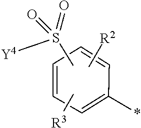

R¹ is —SO₃H,
R² and R³ are H,
Y³ and Y⁴ are —CH₂CH₂—Z, wherein Z is —OSO₃H, and
* signifies the attachment to the azo group of formula (I),
wherein the SO₂Y³ group and the SO₂Y⁴ group are in para-position to the azo groups and wherein R¹ is in ortho-position to the azo group.

In a further embodiment
D¹ is

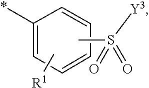

and
D² is

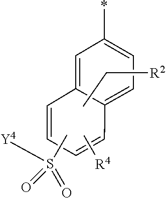

R¹ and R² are independently from each other —H, —SO₃M, unsubstituted or substituted, linear or branched C₁₋₆ alkyl or unsubstituted or substituted, linear or branched C₁₋₆ alkoxy,
R⁴ is H or —SO₃M,
M is independently selected from —H, an alkali metal cation, an alkaline earth metal cation, an organic ammonium cation or a mixture thereof, preferably from an alkali metal cation, an organic ammonium cation or a mixture thereof,
Y³ and Y⁴ are independently from each other —OH, —CH═CH₂ or —CH₂CH₂—Z, wherein Z is —OH or a leaving group which can be eliminated under the action of alkali, and
* signifies the attachment to the azo group of formula (I).

In a further embodiment
D¹ is

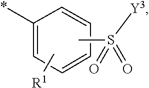

and
D² is

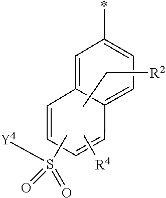

R¹ and R² are independently from each other —H, —SO₃M, unsubstituted or substituted C₁₋₂ alkyl or unsubstituted or substituted C₁₋₂ alkoxy,
R⁴ is H or —SO₃M,
M is independently selected from —H, an alkali metal cation, an alkaline earth metal cation, an organic ammonium cation or a mixture thereof, preferably from an alkali metal cation, an organic ammonium cation or a mixture thereof,
Y³ and Y⁴ are independently from each other —OH, —CH═CH₂ or —CH₂CH₂—Z, wherein Z is —Cl or —OSO₃H, and
* signifies the attachment to the azo group of formula (I),

In a further embodiment
D¹ is

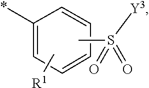

and
D² is

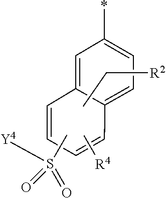

R¹ and R² are independently from each other —H, —SO₃M, unsubstituted or substituted C₁₋₂ alkyl or unsubstituted or substituted C₁₋₂ alkoxy,
M is independently selected from —H, an alkali metal cation, an alkaline earth metal cation or an organic ammonium cation, preferably from an alkali metal cation or an organic ammonium cation,
R⁴ is H,
Y³ is —CH═CH₂ or —CH₂CH₂—Z, wherein Z is —Cl or —OSO₃H,
Y⁴ is —OH, —CH═CH₂ or —CH₂CH₂—Z, wherein Z is —Cl or —OSO₃H, and
* signifies the attachment to the azo group of formula (I).

In a further embodiment
D¹ is

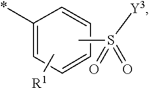

and
D² is

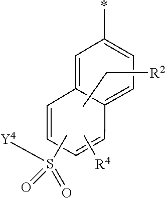

R¹ and R² are independently from each other H, —SO₃M, unsubstituted or substituted C₁₋₂ alkyl or unsubstituted or substituted C₁₋₂ alkoxy,
M is independently selected from —H, an alkali metal cation, an alkaline earth metal cation, an organic ammonium cation or a mixture thereof, preferably from an alkali metal cation, an organic ammonium cation or a mixture thereof,
R⁴ is —H,
Y³ is —CH═CH₂ or —CH₂CH₂—Z, wherein Z is —Cl or —OSO₃H,
Y⁴ is —OH, —CH═CH₂ or —CH₂CH₂—Z, wherein Z is —Cl or —OSO₃H,
* signifies the attachment to the azo group of formula (I),
wherein the SO₂Y³ group is in para-position or in meta-position to the azo group.

In one embodiment, the compound of formula (I) as used in the mixture according to the invention may be obtained in the form of a single compound.

In a further embodiment, the compound of formula (I) as used in the dye mixture according to the invention may be obtained in the form of a mixture comprising or consisting of two or more isomers of compound of formula (I).

The term “isomers” as used within the context of the present application relates to the structural arrangement of at least two radicals connected to an aromatic system, i.e. the term “isomers” describes compounds that are identical with regard to their chemical structure but that are different with regard to their stereochemical structure. In case that the aromatic system is represented by a benzene ring, the term “isomers” relates to the various meta-, ortho- and/or para-substitution patterns. In case that the aromatic system is represented by a naphthalene ring the term “isomers” relates to the various structural arrangements of radicals connected to the naphthalene ring.

Accordingly, a mixture of isomers of compounds of formula (I) relates to the various meta-, ortho- and/or para-substituted compounds of formula (I).

Among the isomers that may be obtained as a single compound or a mixture of two or more isomers, the following positions of the various substituents and their relative position to each other are to be particularly mentioned:

The SO₂Y³ group may be in ortho-, meta-, or para-position to the azo group.

When the SO₂Y³ group is in ortho- position to the azo group, R¹ may be in meta- or para-position to the azo group.

When the SO₂Y³ group is in meta- position to the azo group, R¹ may be in ortho- or para-position to the azo group.

When the SO₂Y³ group is in para- position to the azo group, R¹ may be in ortho- or meta-position to the azo group.

N═N-D¹ and N═N-D² may be at position 2 or 4 or 6 of the 3-aminophenylurea component.

When N═N-D¹ is at position 2 or 4 of the 3-aminophenylurea component, N═N-D² is at position 6 of the 3-aminophenylurea component.

When N═N-D¹ is at position 2 or 6 of the 3-aminophenylurea component, N═N-D² is at position 4 of the 3-aminophenylurea component.

When N═N-D¹ is at position 4 or 6 of the 3-aminophenylurea component, N═N-D² is at position 2 of the 3-aminophenylurea component.

In one embodiment N═N-D¹ is at position 4 of the 3-aminophenylurea component and N═N-D² is at position 2 or 6 thereof.

In another embodiment N═N-D¹ is at position 4 of the 3-aminophenylurea component and N═N-D² is at position 6 thereof.

If D² is

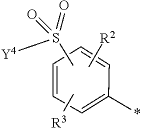

the SO₂Y⁴ group may be in ortho-, meta- or para-position to the azo group.

In one embodiment SO₂Y³ and SO₂Y⁴ are both in the para position compared to the azo-group of D¹ and D², respectively, R¹ is in ortho position to the azo group, N═N-D² is in the 4-position of the 3-aminophenylurea component, and N═N-D¹ is in the 6-position of the 3-aminophenylurea component.

In particular, the compound of formula (I) as used in the dye mixture of the present invention may be one of the following compounds, or a mixture thereof:

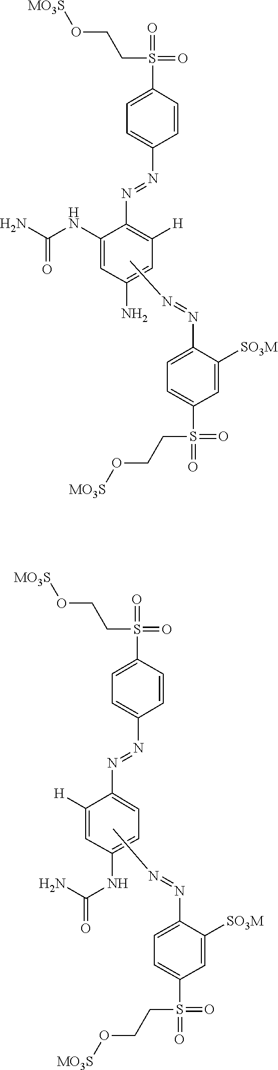

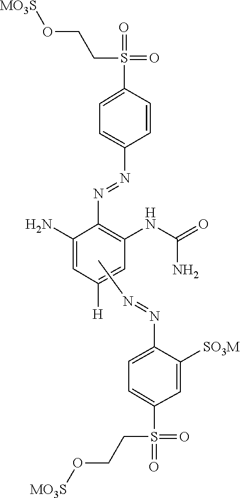

wherein M is independently selected from —H, an alkali metal cation, an alkaline earth metal cation, an organic ammonium cation or a mixture thereof, preferably from an alkali metal cation, an organic ammonium cation or a mixture thereof. It is preferred that M is Na or a mono-, di-, tri- and tetramethyl or mono-, di-, tri- and tetraethyl ammonium cation or a mixture thereof.

In particular, the compound of formula (I) may be one of the following compounds, or a mixture thereof:

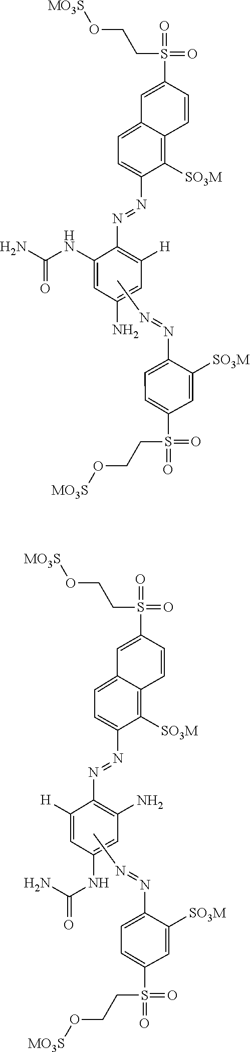

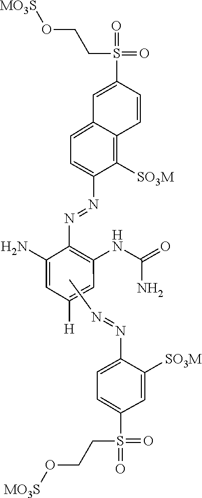

wherein M independently is selected from —H, an alkali metal cation, an alkaline earth metal cation, an organic ammonium cation or a mixture thereof, preferably from an alkali metal cation, an organic ammonium cation or a mixture thereof. It is preferred that M is Na or a mono-, di-, tri- and tetramethyl or mono-, di-, tri- and tetraethyl ammonium cation or a mixture thereof.

### Compounds of General Formulae (II) and (III)

The dye mixture according to the invention comprises at least one compound of the general formula (II) or a salt thereof

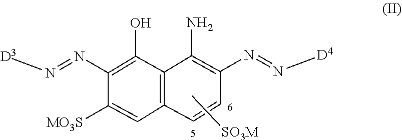

M is independently selected from —H, an alkali metal cation, an alkaline earth metal cation, an organic ammonium cation or a mixture thereof, preferably from an alkali metal cation, an organic ammonium cation or a mixture thereof. It is preferred that M is Na or a mono-, di-, tri- and tetramethyl or mono-, di-, tri- and tetraethyl ammonium cation or a mixture thereof.

The compound of general formula (II) as used in the dye mixture according to the invention exists in two isomers regarding the position of one of the two —SO₃M groups connected to the naphthalene ring, i.e. in the 5-position or the 6-position of the naphthalene ring as indicated in general formula (II). In one embodiment the —SO₃M group is in the 5-position of the naphthalene ring. In a further embodiment the —SO₃M group is in the 6-position of the naphthalene ring. In a preferred embodiment the —SO₃M group is in the 6-position of the naphthalene ring.

In another embodiment, the compound of formula (II) as used in the dye mixture according to the invention may be used in the form of a mixture comprising both isomers with respect to one of the two —SO₃M groups connected to the naphthalene ring, i.e. in the 5-position and the 6-position of the naphthalene ring.

The dye mixture according to the invention comprises optionally at least one compound of the general formula (III) or a salt thereof

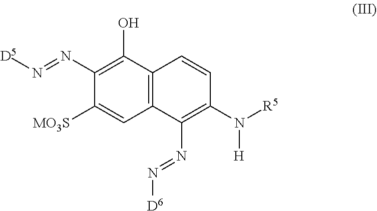

R⁵ is —H or unsubstituted or substituted, linear or branched C₁₋₈ alkyl. The substituents of the alkyl are selected from the group consisting of —SO₃M, —CN and —OH.

M is independently selected from —H, an alkali metal cation, an alkaline earth metal cation, an organic ammonium cation or a mixture thereof, preferably from an alkali metal cation, an organic ammonium cation or a mixture thereof. It is preferred that M is Na or a mono-, di-, tri- and tetramethyl or mono-, di-, tri- and tetraethyl ammonium cation or a mixture thereof.

In a preferred embodiment R⁵ is —H or unsubstituted or substituted, linear or branched C₁₋₄ alkyl, preferably —H or unsubstituted or substituted, linear or branched C₁₋₂ alkyl, more preferably R⁵ is —H, —CH₃ or —CH₂CH₃.

The residues D³ and D⁴ present in general formula (II) and the residues D⁵ and D⁶ present in general formula (III) are independently from each other selected from the general formula (IV), (V) or (VI).

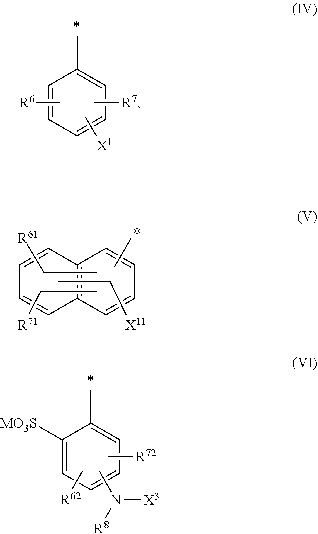

In the residue of general formula (IV)
R⁶ and R⁷ are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein M is independently selected from —H, an alkali metal cation, an alkaline earth metal cation, an organic ammonium cation or a mixture thereof
X¹ is —H or a radical of the general formula —SO₂Y¹, wherein
Y¹ is —OH, —CH═CH₂ or —CH₂CH₂—Z, wherein
Z is —OH or a leaving group which can be eliminated under the action of alkali, preferably wherein Z is selected from the group consisting of halides, phosphate esters, sulfate esters and tertiary amines, preferably halides and sulfate esters, preferably Z is —Cl or —OSO₃H.
* signifies the attachment to the azo group of formula (II) and/or (III).

Within the context of the present application the term substituted alkyl or alkoxy denotes an alkyl residue or an alkoxy residue being substituted with heteroatoms others than hydrogen.

In one embodiment R⁶ and R⁷ are independently from each other —H, —SO₃M, unsubstituted or substituted C₁₋₆ alkyl or unsubstituted or substituted C₁₋₆ alkoxy, preferably —H, —SO₃M, unsubstituted or substituted C₁₋₄ alkyl or unsubstituted or substituted C₁₋₄ alkoxy, more preferably —H, —SO₃M, unsubstituted or substituted C₁₋₂ alkyl or unsubstituted or substituted C₁₋₂ alkoxy with M being independently selected from —H, an alkali metal cation, an alkaline earth metal cation, an organic ammonium cation or a mixture thereof.

Preferably M is an alkali metal cation, preferably Na. Further M is an organic ammonium cation, preferably a mono-, di-, tri- or tetramethyl ammonium cation or a mono-, di-, tri- or tetraethyl ammonium cation or a mixture thereof.

In one embodiment X¹ is —SO₂Y¹, wherein Y¹ is —OH, —CH═CH₂ or —CH₂CH₂—Z, preferably —CH═CH₂ or —CH₂CH₂—Z, wherein Z is —OH or a leaving group which can be eliminated under the action of alkali.

Different structural arrangements of the radicals R⁶, R⁷ and X¹ in formula (IV) result in isomers of compound of general formula (II). The compound of formula (II) as used in the dye mixture according to the invention may be used in the form of only one isomer or in form of a mixture comprising or consisting of two or more isomers relating to the substitution pattern of the residue of general formula (IV).

The X¹ group may be in ortho-, meta-, or para-position to the azo group, preferably the X¹ group is in para-position to the azo group of formula (I) and/or (III).

In the residue of the general formula (V)

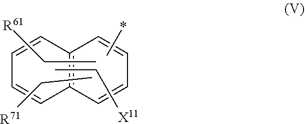

R⁶¹ and R⁷¹ are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein M is independently selected from —H, an alkali metal cation, an alkaline earth metal cation, an organic ammonium cation or a mixture thereof,
X¹¹ is —H or a radical of the general formula —SO₂Y¹, wherein
Y¹ is —OH, —CH═CH₂ or —CH₂CH₂—Z, wherein
Z is —OH or a leaving group which can be eliminated under the action of alkali, in particular Z is selected from the group consisting of halides, phosphate esters, sulfate esters and tertiary amines, preferably halides and sulfate esters, preferably Z is —Cl or —OSO₃H.
* signifies the attachment to the azo group of formula (II) and/or (III)

In one preferred embodiment R⁶¹ and R⁷¹ are independently from each other —H, —SO₃M, unsubstituted or substituted C₁₋₆ alkyl or unsubstituted or substituted C₁₋₆ alkoxy, preferably —H, —SO₃M, unsubstituted or substituted C₁₋₄ alkyl or unsubstituted or substituted C₁₋₄ alkoxy, preferably —H, —SO₃M, unsubstituted or substituted C₁₋₂ alkyl or unsubstituted or substituted C₁₋₂ alkoxy, more preferably —H or —SO₃M with M being independently selected from —H, an alkali metal cation, an alkaline earth metal cation or an organic ammonium cation or a mixture thereof.

Preferably M is an alkali metal cation, preferably Na. Further M is an organic ammonium cation, preferably a mono-, di-, tri- or tetramethyl ammonium cation or a mono-, di-, tri- or tetraethyl ammonium cation or a mixture thereof.

In one embodiment X¹¹ is —SO₂Y¹, wherein Y¹ is —OH, —CH═CH₂ or —CH₂CH₂—Z, preferably —CH═CH₂ or —CH₂CH₂—Z, wherein Z is —OH or a leaving group which can be eliminated under the action of alkali.

In the residue of the general formula (VI)

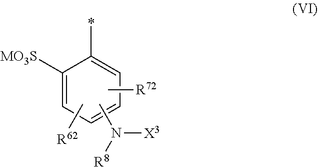

R⁶² and R⁷² are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂,
M is independently selected from —H, an alkali metal cation, an alkaline earth metal cation, an organic ammonium cation or a mixture thereof,
R⁸ is —H, unsubstituted or substituted, linear or branched C₁₋₄ alkyl or unsubstituted or substituted phenyl; and
* signifies the attachment to the azo group of the compounds of formula (II) and/or (III)
X³ is a radical of the general formula (VII), (VIII) or (IX)

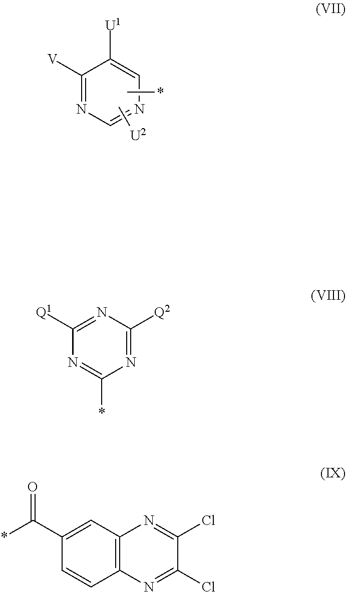

wherein
* signifies the attachment to the amino group of the residue of formula (VI)
V is —F or —Cl;
U¹ and U² are independently from each other —F, —Cl or —H;
Q¹ and Q² are independently from each other —F, —Cl, —NHCN, —OH, unsubstituted or substituted, linear or branched C₁₋₆ alkoxy, phenoxy, mercapto, unsubstituted or substituted, linear or branched C₁₋₆ alkylmercapto, pyridine, carboxypyridino, carbamoylpyridino or a radical of the general formula (X) or (XI)

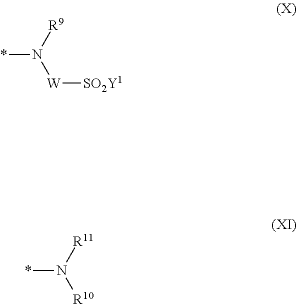

wherein
R⁹ is —H, unsubstituted or substituted, linear or branched C₁₋₆ alkyl, linear or branched sulfo-(C₁₋₆)-alkyl or unsubstituted or substituted phenyl,
R¹⁰ and R¹¹ are independently from each other R⁹ or form together a cyclic ring of the formula —(CH₂)ₙ— with n being 4 or 5 or —(CH₂)₂-E-(CH₂)₂—, wherein E is O, S, SO₂ or NR¹² and R¹² is unsubstituted or substituted, linear or branched C₁₋₆ alkyl,
W is unsubstituted or substituted phenylen, C₁₋₄-alkylene-arylene, C₂₋₆ alkylene; C₂₋₆ alkylene being interrupted by —O—, —S—, SO₂—, —NH—, —CO— and —C(O)NH—, unsubstituted or substituted phenylene-C(O)NH-phenylene or unsubstituted or substituted naphthylene,
Y¹ is —OH, —CH═CH₂ or —CH₂CH₂—Z, wherein Z is —OH or a leaving group which can be eliminated under the action of alkali,
* signifies the attachment to the residue of formula (VIII)

The term “sulfo” as used within the context in the present application, e.g. in “sulfo-(C₁₋₆)-alkyl” signifies “MSO₃—”, wherein M is selected from —H, an alkali metal cation, an alkaline earth metal cation, an organic ammonium cation or a mixture thereof, wherein H is preferred.

In one preferred embodiment R⁶² and R⁷² are independently from each other —H, —SO₃M, unsubstituted or substituted C₁₋₆ alkyl or unsubstituted or substituted C₁₋₆ alkoxy, preferably —H, —SO₃M, unsubstituted or substituted C₁₋₄ alkyl or unsubstituted or substituted C₁₋₄ alkoxy, preferably —H, —SO₃M, unsubstituted or substituted C₁₋₂ alkyl or unsubstituted or substituted C₁₋₂ alkoxy, more preferably —H or —SO₃M with M being independently selected from —H, an alkali metal cation, an alkaline earth metal cation or an organic ammonium cation or a mixture thereof.

Preferably M is an alkali metal cation, preferably Na. Further M is an organic ammonium cation, preferably a mono-, di-, tri- or tetramethyl ammonium cation or a mono-, di-, tri- or tetraethyl ammonium cation or a mixture thereof.

Particular Z is selected from the group consisting of halides, phosphate esters, sulfate esters and tertiary amines, preferably halides and sulfate esters. Preferably Z is —Cl or —OSO₃H.

If R⁸ is substituted phenyl, the substituents of the phenyl are selected from the group consisting of unsubstituted or substituted, linear or branched C₁₋₄ alkyl, unsubstituted or substituted, linear or branched C₁₋₄ alkoxy, —SO₃M, —COOM and halogen with M being independently selected from —H, an alkali metal cation, an alkaline earth metal cation or an organic ammonium cation or a mixture thereof, preferably R⁸ is H, unsubstituted or substituted, linear or branched C₁₋₄ alkyl, preferably R⁸ is H.

If R⁹ is substituted phenyl the substituents of the phenyl are selected from the group consisting of unsubstituted or substituted, linear or branched C₁₋₄ alkyl, unsubstituted or substituted, linear or branched C₁₋₄ alkoxy, —SO₃M, —COOM, .NHC(O)CH₃, —NH—C(O)—NH₂ and halogen with M being independently selected from —H, an alkali metal cation, an alkaline earth metal cation or an organic ammonium cation or a mixture thereof.

Preferably R⁹ is —H, unsubstituted or substituted, linear or branched C₁₋₆ alkyl, preferably R⁹ is —H, unsubstituted or substituted, linear or branched C₁₋₄ alkyl, more preferably R⁹ is —H, unsubstituted or substituted C₁₋₂ alkyl.

Preferably X³ is a radical of general formula (VII), wherein V is —F or —Cl and U¹ and U² are from each other independently —F or —Cl.

In one preferred embodiment X³ is a radical of general formula (VIII), wherein Q¹ and Q² are independently from each other —F, —Cl, unsubstituted or substituted, linear or branched C₁₋₆ alkoxy or a radical of the general formula (X) or (XI), particularly preferred Q¹ and Q² are independently from each other —F, —Cl or a radical of the general formula (X).

Preferably W of formula (X) is substituted phenylen, wherein the phenylen is substituted with 1 or 2 substituents, the substituents are independently selected from the group consisting of unsubstituted or substituted, linear or branched C₁₋₄ alkly, unsubstituted or substituted, linear or branched C₁₋₄ alkoxy, —COOM, —SO₃M, —Cl, —Br with M being independently selected from —H, an alkali metal cation, an alkaline earth metal cation or an organic ammonium cation or a mixture thereof.

Preferably W of formula (X) is substituted phenylene-C(O)NH-phenylene, wherein the substituents are selected from the group consisting of unsubstituted or substituted, linear or branched C₁₋₄ alkyl, unsubstituted or substituted, linear or branched C₁₋₄-alkoxy, —OH, —SO₃M, —COOM, —C(O)—NH₂, —NH—C(O)—NH₂ and halogen with M being independently selected from —H, an alkali metal cation, an alkaline earth metal cation or an organic ammonium cation or a mixture thereof.

Preferably W of formula (X) is substituted naphthylene, wherein the naphthylene is substituted by 1 or 2 —SO₃M radicals with M being selected from —H, an alkali metal cation, an alkaline earth metal cation or an organic ammonium cation or a mixture thereof.

In one embodiment wherein Y¹ is —OH, —CH═CH₂ or —CH₂CH₂—Z, preferably —CH═CH₂ or —CH₂CH₂—Z, wherein Z is —OH or a leaving group which can be eliminated under the action of alkali.

In one embodiment D³ is a radical of general formula (IV) or general formula (VI).

Different structural arrangements of the radicals R⁶², R⁷² and NR⁸X³ in formula (VI) result in isomers of compound of general formula (II). The compound of formula (II) as used in the dye mixture according to the invention may be used in the form of only one isomer or in the form of a mixture comprising or consisting of two or more isomers relating to the substitution pattern of the radical of general formula (VI).

The NR⁸X³ group may be in ortho-, meta-, or para-position to the —SO₃M group of the benzene ring, preferably the NR⁸X³ group is in para-position to the —SO₃M group.

In one preferred embodiment D³ is a radical of formula (IV),
wherein
R⁶ and R⁷ are independently from each other —H, —SO₃M, unsubstituted or substituted C₁₋₆ alkyl or unsubstituted or substituted C₁₋₆ alkoxy,
   preferably —H, —SO₃M, unsubstituted or substituted C₁₋₂ alkyl or unsubstituted or substituted C₁₋₂ alkoxy,
   more preferably —H or —SO₃M;
M being independently selected from —H, an alkali metal cation, an alkaline earth metal cation or an organic ammonium cation or a mixture thereof, preferably from an alkali metal cation or an organic ammonium cation or a mixture thereof,
X¹ is —SO₂Y¹,
wherein Y₁ is —OH, —CH═CH₂ or —CH₂CH₂—Z,
   preferably —CH═CH₂ or —CH₂CH₂—Z, wherein
Z is —OH or a leaving group which can be eliminated under the action of alkali, preferably —Cl or —OSO₃H.

Among the isomers that may be obtained for structural formula (IV) in one preferred embodiment of D³the X¹ group is in para-position to the azo group.

In another preferred embodiment D³ is a radical of general formula (VI), wherein
R⁶² and R⁷² are independently —H, unsubstituted or substituted, linear or branched C₁₋₆ alkyl, unsubstituted or substituted, linear or branched C₁₋₆ alkoxy, or —SO₃M,
   preferably —H, unsubstituted or substituted C₁₋₄ alkyl, unsubstituted or substituted C₁₋₄ alkoxy or —SO₃M,
   more preferably —H or —SO₃M;
M being independently selected from —H, an alkali metal cation, an alkaline earth metal cation or an organic ammonium cation or a mixture thereof, preferably from an alkali metal cation or an organic ammonium cation or a mixture thereof,
R⁸ is —H or unsubstituted or substituted, linear or branched C₁₋₄ alkyl, preferably —H or unsubstituted or substituted C₁₋₂ alkyl, more preferably —H;
X³ is a radical of the general formula (VII), (VIII) or (IX)

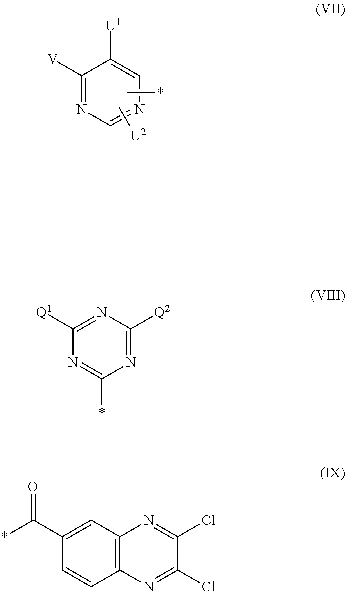

wherein the radicals V, U¹, U², Q¹, Q² are defined as above and * signifies the attachment to the amino group of the residue of formula (VI).

In one embodiment of D³, X³ is a radical of formula (VII) or (VIII).

In one preferred embodiment of D³, X³ of formula (VI) is a radical of formula (VII), wherein U¹ and U² are independently from each other —F, —Cl or —H and V is —F or —Cl.

In one preferred embodiment of D³, X³ of formula (VI) is a radical of general formula (VIII), wherein Q¹ and Q² are independently from each other —F, —Cl, unsubstituted or substituted, linear or branched C₁₋₆ alkoxy or a radical of the general formula (X) or (XI), particularly preferred Q¹ and Q² are independently from each other —F, —Cl or a radical of the general formula (X).

In one preferred embodiment of D³, R⁹ of formula (X) is H—, unsubstituted or substituted, linear or branched C₁₋₆ alkyl, preferably R⁹ is —H, unsubstituted or substituted, linear or branched C₁₋₄ alkyl, more preferably R⁹ is —H, unsubstituted or substituted C₁₋₂ alkyl.

In one preferred embodiment of D³, W of formula (X) is substituted or unsubstituted phenylen.

In one preferred embodiment of D³, Y¹ of formula (X) is —OH, —CH═CH₂ or —CH₂CH₂—Z, preferably —CH═CH₂ or —CH₂CH₂—Z, wherein Z is —OH or a leaving group which can be eliminated under the action of alkali, preferably —Cl or —OSO₃H.

In one preferred embodiment D⁴ is a radical of general formula (IV),
wherein
R⁶ and R⁷ are independently —H, —SO₃M, unsubstituted or substituted C₁₋₆ alkyl or unsubstituted or substituted C₁₋₆ alkoxy,
   preferably —H, —SO₃M, unsubstituted or substituted C₁₋₂ alkyl or unsubstituted or substituted C₁₋₂ alkoxy,
   more preferably —H or —SO₃M;
M being independently selected from —H, an alkali metal cation, an alkaline earth metal cation or an organic ammonium cation or a mixture thereof, preferably from an alkali metal cation or an organic ammonium cation or a mixture thereof,
X¹ is —SO₂Y₁
wherein Y₁ is —OH, —CH═CH₂ or —CH₂CH₂—Z,
   preferably —CH═CH₂ or —CH₂CH₂—Z, wherein
Z is —OH or a leaving group which can be eliminated under the action of alkali, preferably —Cl or —OSO₃H.

In particular, the compound of formula (II) as used in the dye mixture according to the present invention may be the following compound:

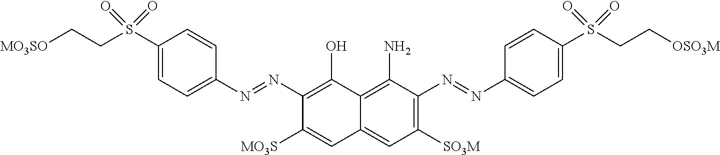

wherein M is independently selected from —H, an alkali metal cation, an alkaline earth metal cation or an organic ammonium cation or a mixture thereof.

In one embodiment D⁵ is a radical of general formula (IV),
wherein
R⁶ and R⁷ are independently —H, —SO₃M, unsubstituted or substituted C₁₋₆ alkyl or unsubstituted or substituted C₁₋₆ alkoxy,
   preferably —H, —SO₃M, unsubstituted or substituted C₁₋₂ alkyl or unsubstituted or substituted C₁₋₂ alkoxy,
   more preferably —H or —SO₃M;
M being independently selected from —H, an alkali metal cation, an alkaline earth metal cation or an organic ammonium cation or a mixture thereof, preferably from an alkali metal cation or an organic ammonium cation or a mixture thereof,
X¹ is —SO₂Y₁
wherein Y₁ is —OH, —CH═CH₂ or —CH₂CH₂—Z,
   preferably —CH═CH₂ or —CH₂CH₂—Z, wherein
Z is —OH or a leaving group which can be eliminated under the action of alkali, preferably —Cl or —OSO₃H.

In one preferred embodiment D⁶ is a radical of general formula (IV),
wherein
R⁶ and R⁷ are independently —H, —SO₃M, unsubstituted or substituted C₁₋₆ alkyl or unsubstituted or substituted C₁₋₆ alkoxy, preferably —H, —SO₃M, unsubstituted or substituted C₁₋₂ alkyl or unsubstituted or substituted C₁₋₂ alkoxy, more preferably —H or —SO₃M;
M being independently selected from —H, an alkali metal cation, an alkaline earth metal cation or an organic ammonium cation or a mixture thereof, preferably from an alkali metal cation or an organic ammonium cation or a mixture thereof,
X¹ is —SO₂Y₁
wherein Y₁ is —OH, —CH═CH₂ or —CH₂CH₂—Z, preferably —CH═CH₂ or —CH₂CH₂—Z,
wherein
Z is —OH or a leaving group which can be eliminated under the action of alkali, preferably —Cl or —OSO₃H.

In particular, the compound of formula (III) as used in the dye mixture according to the present invention may be the following compound:

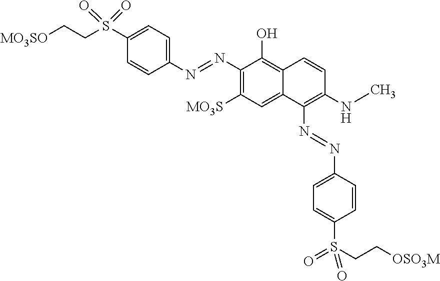

wherein M is independently selected from —H, an alkali metal cation, an alkaline earth metal cation or an organic ammonium cation or a mixture thereof.

The dye mixture according to the invention can either be prepared by mixing the individual components of the dye mixture, i.e. by mixing at least one compound of the general formula (I) or a salt thereof and at least one compound of the general formula (II) or a salt thereof and optionally at least one compound of the general formula (III) or a salt thereof. Alternatively, the dye mixture according to the invention may be prepared in a one pot reaction in which the individual components, i.e. at least one compound of the general formula (I) or a salt thereof and at least one compound of the general formula (II) or a salt thereof and optionally at least one compound of the general formula (III) or a salt thereof, are synthesized in one reactor and thus resulting in the dye mixture according to the invention.

In a second aspect, the invention relates to a composition comprising or consisting of at least the dye mixture according to the invention and a medium.

The medium is water, a mixture of water and an organic solvent, an organic solvent free from water, or a low melting point solid.

In one embodiment, the composition according to the invention comprises or consists of components (d) and (e), wherein
(d) is from 0.01 to 30 parts of the dye mixture according to the invention; and
(e) is from 70 to 99.99 parts of water or a medium comprising a mixture of water and an organic solvent, or an organic solvent free from water, or a low melting point solid,
   wherein all parts are by weight and the number of parts of components (d)+(e) amounts to 100.

Preferably the amount of component (d) is from 0.1 to 20, or from 0.5 to 15, or from 1 to 5 parts. The amount of component (e) is from 80 to 99.9, or from 85 to 99.5, or from 95 to 99 parts.

If the medium comprises a mixture of water and an organic solvent or an organic solvent free from water, component (d) is completely dissolved in component (e).

In one embodiment, component (d) has a solubility in component (e) at 20° C. of at least 10 wt %, which means that at least 10 wt % of the initially used component (d) are dissolved in component (e). This allows the preparation of concentrates which may be used to prepare diluted inks and reduces the chance of the dye mixture according to the invention from precipitating if evaporation of the liquid medium occurs during storage.

If the medium comprises a mixture of water and an organic solvent, the weight ratio of water to organic solvent is from 99:1 to 1:99, or from 99:1 to 50:50 or from 95:5 to 80:20.

Preferably, the organic solvent present in the mixture of water and organic solvent is a water-miscible organic solvent or a mixture of such solvents, which denotes in the context of the present application C₁₋₄-alkanols, or methanol, ethanol, n-propanol, isopropanol, n-butanol, sec-butanol, tert-butanol, n-pentanol, cyclopentanol and cyclohexanol; linear amides, or dimethylformamide or dimethylacetamide; ketones and ketone-alcohols, or acetone, methyl ether ketone, cydohexanone and diacetone alcohol; water-miscible ethers, or tetrahydrofuran and dioxane; diols, or diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, or diethylene glycol, triethylene glycol, polyethylene glycol and polypropylene glycol; triols, or glycerol and 1,2,6-hexanetriol; mono-C₁₋₄-alkyl ethers of diols, or mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether, cyclic amides, or 2-pyrrolidone, N-methyl-2-pyrrolidone, N-ethyl-2-pyrrolidone, caprolactam and 1,3-dimethylimidazolidone; cyclic esters, or caprolactone; sulfoxides, or dimethyl sulfoxide and sulfolane. In particular the liquid medium comprises water and 2 or more, especially from 2 to 8, water-soluble organic solvents.

Water-soluble organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, or mono-C₁₋₄-alkyl ethers of diols having 2 to 12 carbon atoms, especially 2-methoxy-2-ethoxy-2-ethoxyethanol.

Preferably, the medium comprises:
(f) from 75 to 95 parts water; and
(g) from 25 to 5 parts in total of at least one solvent selected from diethylene glycol, 2-pyrrolidone, thiodiglycol, N-methylpyrrolidone, cyclohexanol, caprolactone, caprolactam and pentane-1,5-diol or a mixture thereof;
   wherein the parts are by weight and the sum of the parts (f) and (g)=100.

Examples of further suitable media comprising a mixture of water and at least one organic solvent are described in U.S. Pat. Nos. 4,963,189, 4,703,113, 4,626,284 and EP 4 251 50 A.

If the liquid medium comprises an organic solvent free from water (i.e. less than 1% water by weight present in the organic solvent), the solvent has a boiling point from 30° C. to 200° C., or from 40° C. to 150° C., or from 50° C. to 125° C.

The organic solvent may be water-immiscible, water-miscible or a mixture of such solvents.

Water-immiscible solvents include, for example, aliphatic hydrocarbons; esters, or ethyl acetate; chlorinated hydrocarbons, or CH₂Cl₂ and ethers, or diethyl ether; and mixtures thereof.

If the liquid medium comprises a water-immiscible organic solvent, a polar solvent is included to enhance solubility of the dye mixture according to the invention in the liquid medium. Examples of polar solvents include C₁₋₄-alcohols.

If the liquid medium is an organic solvent free from water, the liquid medium comprises a ketone, for example methyl ethyl ketone or an alcohol, for example a C₁₋₄-alkanol, or ethanol or propanol or a mixture thereof.

If the medium is free from water the medium may be a single organic solvent or a mixture of two or more organic solvents.

In particular, the medium is an organic solvent free from water it is a mixture of 2 to 5 different organic solvents. This allows a medium to be selected which gives good control over the dyeing characteristics and storage stability of the composition according to the invention.

Media comprising an organic solvent free from water are particularly useful where fast dyeing times are required and particularly when printing onto hydrophobic and non-absorbent substrates, for example plastics, metal and glass.

The dye mixture according to the invention exhibits a high solubility in aqueous media. Accordingly, in one embodiment, the liquid medium is water or a mixture of water and at least one water miscible organic solvent.

The composition according to the invention may also contain additional components conventionally used in inkjet printing inks, for example viscosity and surface tension modifiers, corrosion inhibitors, biocides, coagulation reducing additives and surfactants which may be ionic or non-ionic.

The composition according to the invention is useful as inks, or printing inks, or inkjet printing inks, printing pastes, or in a dyeing bath for dyeing a substrate.

Inks, printing inks or inkjet printing inks have a concentration of less than 100 parts per million, or less than 50 parts per million, in total of halide ions and divalent and trivalent metals. This reduces nozzle blockage in inkjet printing heads, particularly in thermal inkjet printers.

In a third f fourth aspect, the invention relates to the use of dye mixture according to the first aspect of the invention or a composition according to the second aspect of the invention for the preparation of an ink, a printing ink, an inkjet printing ink, a printing paste or a dyeing bath for printing or dyeing a substrate.

According to this aspect, the invention also relates to an ink or printing ink or inkjet printing ink or printing paste or dyeing bath for printing or dyeing a substrate, comprising the dye mixture according to the invention or composition according to the invention.

In a fifth aspect, the invention relates to a process for dyeing or printing a substrate with a dye mixture according to the first aspect of the invention or a composition according to the second aspect of the invention.

The dye mixture according to the first aspect of the invention and the composition according to the second aspect of the invention are useful as dyestuffs, especially for the coloration of inks for inkjet printing ink. The dye mixtures according to the invention and the compositions according to the invention are also suitable for dyeing and printing in a conventional manner. The dye mixture according to the invention exhibits a high solubility in aqueous media and provides dyeings which exhibit good high light fastness and wet/washing fastness when applied on a substrate or incorporated into inks for inkjet printing.

In one embodiment, the invention relates to a process for dyeing or printing a substrate comprises contacting the dye mixture according to the first aspect of the invention or a composition according to the second aspect of the invention with said substrate.

The term “dyeing” as used herein encompasses all processes of applying color to a substrate. Dyeing is normally carried out in a dyebath containing at least one dye, or a dye composition.

The dyeing process can an exhaust-dyeing process, in which temperatures within the range of from 40 to 100° C., or 50 to 80° C. are used.

The term “exhaust dyeing process” as used herein is to be understood as a process in which the dye is gradually transferred from a relatively large volume dyebath to the organic substrate which is thereby dyed over a relatively long period of time (see A Review of Textile Dyeing Processes, Perkins W. S, 1991. Textile Chemist & Colorist vol. 23(8) 23-27).

The dyeing process can be a continuous dyeing process.

The term “continuous dyeing process” as used herein is to be understood as a process in which the substrate to be dyed is fed continuously into a dye bath. Examples of a continuous dyeing process are pad-steam process or pad-dry process.

The term “printing” as used herein is to be understood as a process to reproduce text or images on a substrate. The printing process may be an inkjet printing process, which is a non-impact printing technique in which droplets of ink are ejected through a fine nozzle onto a substrate without bringing the nozzle into contact with the substrate.

The term “substrate” as used herein encompasses all substrates of natural or synthetic origin. The substrate may be present in the form of a textile, (i.e. material comprising or consisting of natural or synthetic polyamides such as wool, silk and all nylon types, cellulose or cotton), or in form of a plastic object. The term “substrate” also encompasses hydroxy- or nitrogen-containing materials.

Further examples for the form/appearance of the substrate are yarn, woven fabric, loop-formingly knitted fabric carpet comprising or consisting of an organic substrate, e.g. natural or synthetic polyamides (for example wool, silk and all nylon types), polyurethanes, cellulose as well as hydrophobic and non-absorbent substrates, for example plastics, metal and glass.

The substrates for dyeing can also be leather and fibrous materials, which comprise natural or synthetic polyamides and, particularly, natural or regenerated cellulose such as cotton, viscose and spun rayon.

In one embodiment, the substrates for dyeing are textiles comprising cotton.

Suitable substrates which can be dyed using the dye mixture according to the invention, in particular for printing are paper, plastic, textiles, metal, glass, or an overhead projector slide.

Suitable plastic objects which can be dyed using the dye mixture according to the invention can be formed by any traditional method known in the state of the art, like molding methods. Further, the plastic object can be formed by newly developed methods like 3D-printing methods. Commonly known 3D-printing methods are for example binder jetting, triple jetting (also referred to as PolyJet, MultiJet), stereolithography (SLA), digital light processing (DLP), multijet printing, fused deposition modeling (FDM), selective heat sintering (SHS), selective laser sintering (SLS), laminated object manufacturing (LOM), wax deposition modeling (WDM), 3-dimensional inkjet printing (3DP), thermoplastic extrusion, smooth curvature printing, selective deposition lamination, hybrid CNC, fused filament fabrication (FFF).

Dyeing or printing may be carried out in accordance with known methods conventional in the fiber-reactive dyestuff field, respectively in the field for dyeing plastic objects.

The dyeings and prints derived from the dye mixture according to the invention or the composition according to the invention exhibit good wet/washing fastness properties such as wash, water, sea water and sweat fastness and in particular excellent light fastness. They also exhibit good resistance to oxidation agents such as chlorinated water, hypochlorite bleach, peroxide bleach and perborate-containing washing detergents.

The dye mixture according to the invention displays good compatibility with other known dyestuffs. Accordingly, the dye mixture according to the invention may be mixed with other dyestuffs to form a composition, which can be used to dye or print suitable substrates. Said other dyestuffs must be compatible with the dye mixture according to the invention, i.e. they must have similar dyeing or printing properties, for example fastness properties.

The dye mixture according to the invention can also be used in the production of pulp dyeing of bleached and unbleached paper. The dye mixture according to the invention can furthermore be used in dyeing paper according to the dip dyeing process (i.e. the process of submerging selected portions of materials into a dye bath to create a design).

The process for printing an image on a substrate comprises applying thereto an ink containing a dye mixture according to the invention by means of an inkjet printer.

In one embodiment the ink contained in the inkjet printer cartridge is a composition according to the second aspect of the present invention.

The dye mixtures according to the invention and the compositions according to the invention provide sharp, non-feathered images when applied by printing techniques (classical and non-impact printing techniques) having good water-fastness, light-fastness and optical density. Details of these printing technologies are described for example in the inkjet printing section of R. W. Kenyon in “Chemistry and Technology of Printing and Imaging Systems”, Peter Gregory (editor), Blackie Academic & Professional, Chapmann & Hall 1996, pages 113 to 138, and references cited therein.

The inkjet printer cartridge contains an ink, characterized in that the ink contains the dye mixture according to the first aspect of the invention.

If the substrate is a textile the ink according to the invention is applied thereto by:

i) applying the composition to the textile using an inkjet printer, and

ii) heating the printed textile at a temperature of from 50° C. to 250° C.

Preferably the textiles are natural, synthetic or semi-synthetic materials. Examples of natural textiles include wool, silk, hair and cellulosic materials, particularly cotton, jute, hemp, flax and linen. Examples of synthetic and semi-synthetic textiles include polyamides, polyesters, polyacrylonitriles and polyurethanes.

In one embodiment, the textile has been treated with an aqueous pre-treatment composition comprising a thickening agent and optionally a water-soluble base and a hydrotropic agent and dried prior to step i) above.

The pre-treatment composition comprises a solution of the base and the hydrotropic agent in water containing the thickening agent. Particularly preferred pre-treatment compositions are described in more detail in EP534660A1.

In a sixth aspect, the invention relates to a substrate, comprising the dye mixture according to the invention or the composition according to the invention, wherein the term substrate is to be understood as defined before.

Further the invention relates to a substrate obtainable by a process for dyeing and/or printing said substrate, comprising contacting a dye mixture according to the first aspect of the invention or a composition according to the third aspect of the invention with said substrate.

### EXAMPLES

The invention is further illustrated by the following examples in which all parts and percentages are by weight unless otherwise stated and all temperatures are given in degrees Centigrade. The present invention is not be limited by the examples.

### Example 1

In a separate reactor (i) 17.3 parts 3-aminophenylurea are dissolved in 50 parts of ice water. pH is adjusted to 4-4.5 with sodium acetate. In a separate reactor (ii) 71.64 parts 1-amino-8-hydroxy naphthalene-3,6-disulfonic acid monosodium salt, 11.18 parts N-Methyl-(7-amino-4-hydroxynaphthalene-2-sulfonic acid) are suspended in 200 parts of water. Using sodium hydroxide pH is adjusted 6.5 to 7. In a third reactor (iii) 233.0 parts of 4-(β-sulfatoethylsulfonyl)anilin are suspended in 300 parts of ice water and 223.7 parts of 30% hydrochloric acid and diazotized at 0 to 5° C. by dropwise addition of 146.3 parts of 40% sodium nitrite solution. After removal of excess of nitrite with amidosulfonic acid, suspension of reactor (i) is added at 0 to 5° C. to reactor (iii). Then solution of reactor (ii) is added dropwise at 0 to 5° C. to reactor (iii). After addition is completed, pH is adjusted slowly to 6.0 to 6.5 and is held constant using sodium carbonate until the end of the coupling. Temperature was allowed to increase up to 10° C. during that time. After isolation by salting out with sodium chloride, evaporation in vacuum or spray drying a dye mixture as blackish powder containing the compounds (1-I) to (1-III) is obtained, which leaves black dyeings on cellulosic material, especially on cotton. The dyeings exhibit high fastness properties on the substrates.

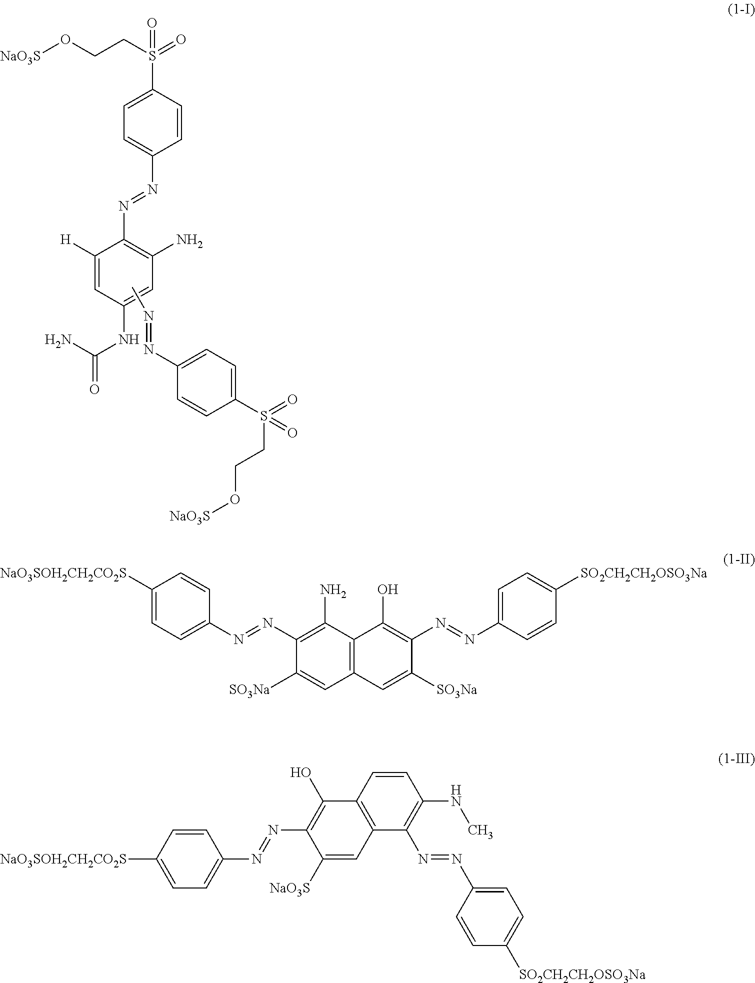

### Example 2

In a separate reactor (i) 111.7 parts 1-amino-8-hydroxy naphthalene-3,6-disulfonic acid monosodium salt, 14.18 parts N-methyl-(7-amino-4-hydroxynaphthalene-2-sulfonic acid) are suspended in 300 parts of water. Using sodium hydroxide pH is adjusted 6.5 to 6.8. In another reactor (ii) 228.4 parts of 4-(β-sulfatoethylsulfonyl)anilin are suspended in 300 parts of ice water and 219.0 parts of 30% hydrochloric acid and diazotized at 0 to 5° C. by dropwise addition of 143.3 parts of 40% sodium nitrite solution. After removal of excess of nitrite with amidosulfonic acid, solution of reactor (i) is added at 0 to 5° C. and held at that temperature until the end of the first coupling stage where compounds of formulae (2-I) and (2-II) are obtained.

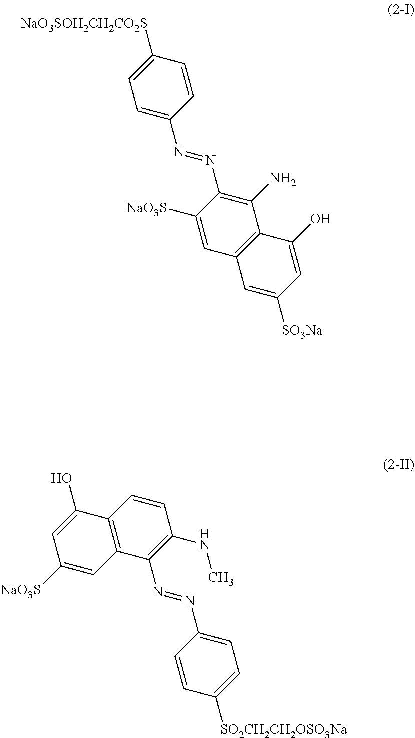

After addition pH is adjusted slowly to 6.0 to 6.2 at 8 to 10° C. and is held constant using sodium carbonate and held at that temperature until the end of the second coupling stages, where compounds (1-II) and (1-III) are obtained. Temperature was allowed to increase up to 20° C. during that time.

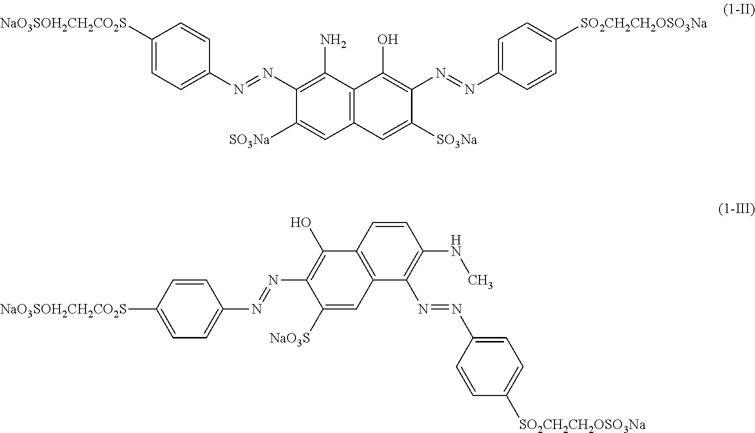

After isolation by salting out with sodium chloride, evaporation in vacuum or spray drying a dye mixture as a brownish powder containing compounds (1-II) and (1-III) is obtained, which can be shaded with the dyes of formula (1-I). The resulting black dye mixture leaves black dyeings on cellulosic material, especially on cotton. The dyeings exhibit high fastness properties on the substrates.

### Example 3 to 26

Table 1 shows further dyes of formula (I) useful in the dye mixture according to the invention. Exemplarily, the dyes are shown in their free-acid form, but might also be used in their salt form as described in the general part of the present application. The dyes leave yellow to reddish-brown dyeings or prints on cotton revealing good fastness properties. In combination with bluish compounds of formula (II) and reddish components of formula (III) of the invention these dyestuffs work very well as yellow shading component for black mixtures with excellent fastness behaviour.

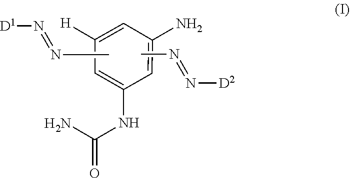

TABLE 1
(*signifies the attachment to the azo-group)

| Example | D¹ | D² | λₘₐₓ [nm] |
|---|---|---|---|
| 3 | 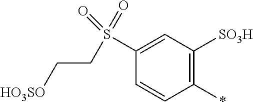 | 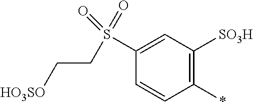 | 470 |
| 4 | 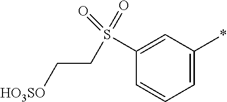 | 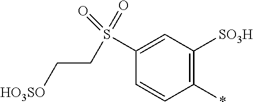 | 480 |
| 5 | 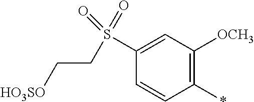 | 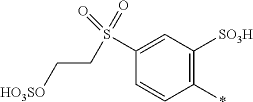 | 485 |
| 6 | 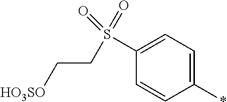 | 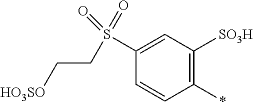 | 473 |
| 7 | 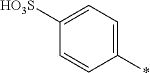 [SMILES: *c1ccc(S(=O)(=O)O)cc1] | 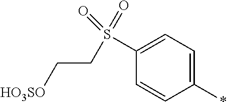 | 482 |
| 8 | 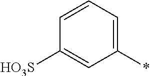 [SMILES: *c1cccc(S(=O)(=O)O)c1] | 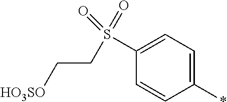 | 479 |
| 9 | 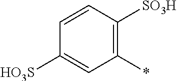 [SMILES: *c1cc(S(=O)(=O)O)ccc1S(=O)(=O)O] | 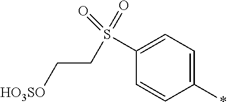 | 477 |
| 10 | 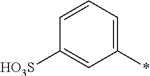 [SMILES: *c1cccc(S(=O)(=O)O)c1] | 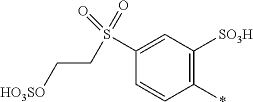 | 478 |
| 11 | 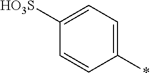 [SMILES: *c1ccc(S(=O)(=O)O)cc1] | 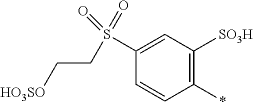 | 467 |
| 12 | 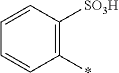 [SMILES: *c1ccccc1S(=O)(=O)O] | 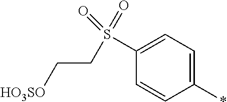 | 481 |
| 13 | 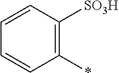 [SMILES: *c1ccccc1S(=O)(=O)O] | 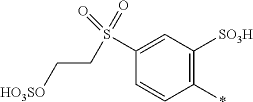 | 479 |
| 14 | 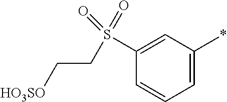 | 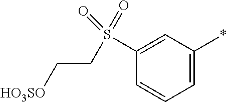 | 469 |
| 15 | 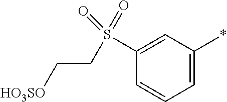 | 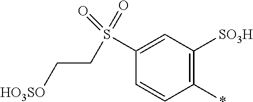 | 470 |
| 16 | 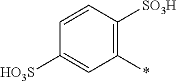 [SMILES: *c1cc(S(=O)(=O)O)ccc1S(=O)(=O)O] | 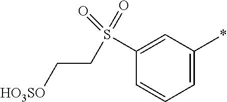 | 466 |
| 17 | 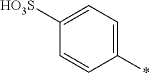 [SMILES: *c1ccc(S(=O)(=O)O)cc1] | 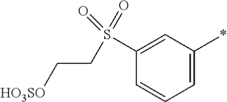 | 467 |
| 18 | 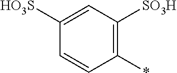 [SMILES: *c1ccc(S(=O)(=O)O)cc1S(=O)(=O)O] | 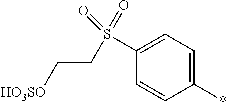 | 467 |
| 19 | 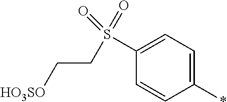 | 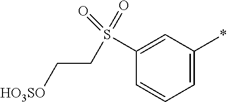 | 470 |
| 20 | 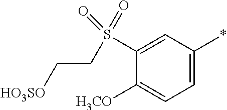 | 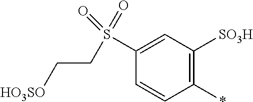 | 481 |
| 21 | 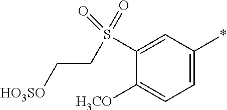 | 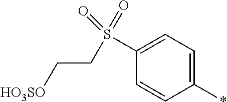 | 483 |
| 22 | 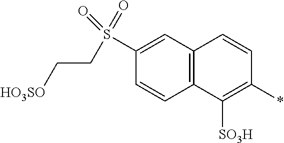 | 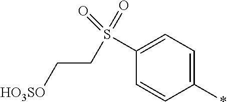 | 482 |
| 23 | 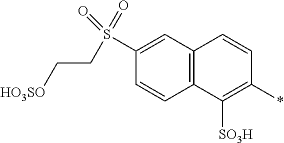 | 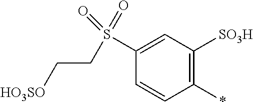 | 480 |
| 24 | 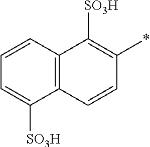 [SMILES: *c1ccc2c(S(=O)(=O)O)cccc2c1S(=O)(=O)O] | 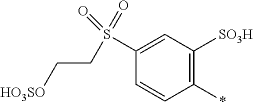 | 481 |
| 25 | 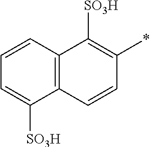 [SMILES: *c1ccc2c(S(=O)(=O)O)cccc2c1S(=O)(=O)O] | 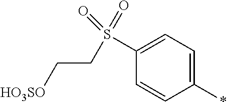 | 483 |
| 26 | 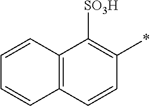 [SMILES: *c1ccc2ccccc2c1S(=O)(=O)O] | 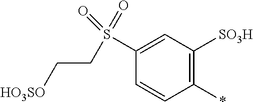 | 483 |

### Example 27 to 52

Table 2 shows further dyes of formula (II) useful in the dye mixture according to the invention. Exemplarily, the dyes are shown in their free-acid form, but might also be used in their salt form as described in the general part of the present application. The dyes leave navy to dark blue dyeings or prints on cotton revealing good fastness properties. In combination with yellowish compounds of formula (I) and reddish components of formula (III) of the invention these dyestuffs work very well for black mixtures with excellent fastness behaviour.

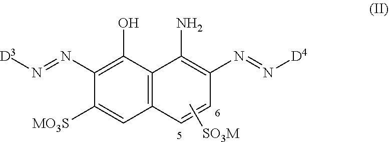

TABLE 2
(*signifies the attachment to the azo-group)

| Ex- | | | Position | |
|---|---|---|---|---|
| am- | | | Sulfo- | λₘₐₓ |
| ple | D³ | D⁴ | group | [nm] |
| 27 | 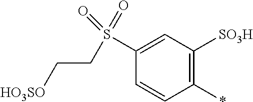 | 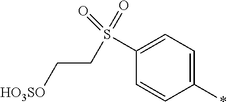 | 6 | 589 |
| 28 | 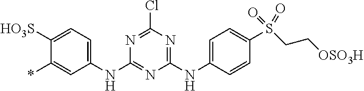 | 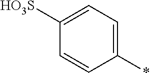 [SMILES: *c1ccc(S(=O)(=O)O)cc1] | 6 | 581 |
| 29 | 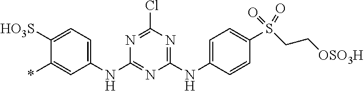 | 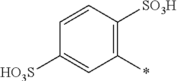 [SMILES: *c1cc(S(=O)(=O)O)ccc1S(=O)(=O)O] | 6 | 584 |
| 30 | 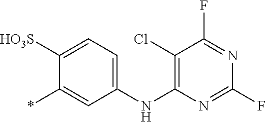 [SMILES: *c1cc(Nc2nc(F)nc(F)c2Cl)ccc1S(=O)(=O)O] | 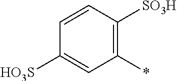 [SMILES: *c1cc(S(=O)(=O)O)ccc1S(=O)(=O)O] | 6 | 583 |
| 31 | 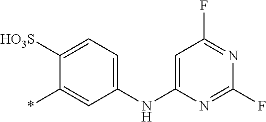 [SMILES: *c1cc(Nc2cc(F)nc(F)n2)ccc1S(=O)(=O)O] | 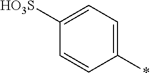 [SMILES: *c1ccc(S(=O)(=O)O)cc1] | 6 | 584 |
| 32 | 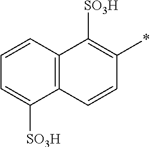 [SMILES: *c1ccc2c(S(=O)(=O)O)cccc2c1S(=O)(=O)O] | 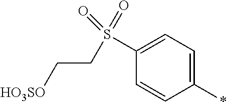 | 6 | 588 |
| 33 | 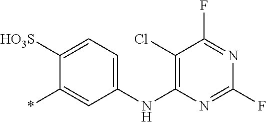 [SMILES: *c1cc(Nc2nc(F)nc(F)c2Cl)ccc1S(=O)(=O)O] | 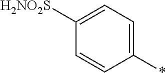 [SMILES: *c1ccc(S(N)(=O)=O)cc1] | 6 | 585 |
| 34 | 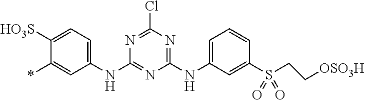 | 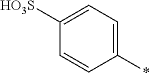 [SMILES: *c1ccc(S(=O)(=O)O)cc1] | 6 | 581 |
| 35 | 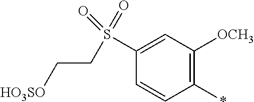 | 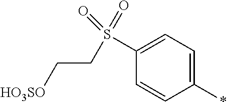 | 6 | 592 |
| 36 | 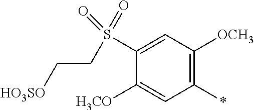 | 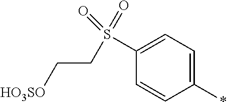 | 6 | 599 |
| 37 | 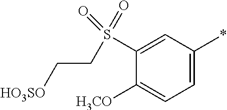 | 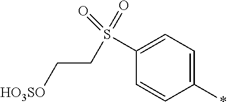 | 6 | 593 |
| 38 | 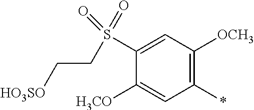 | 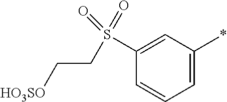 | 6 | 600 |
| 39 | 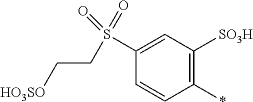 | 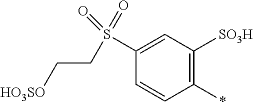 | 6 | 588 |
| 40 | 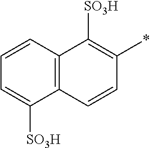 [SMILES: *c1ccc2c(S(=O)(=O)O)cccc2c1S(=O)(=O)O] | 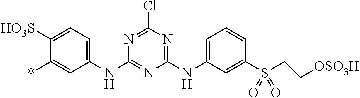 | 6 | 586 |
| 41 | 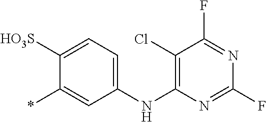 [SMILES: *c1cc(Nc2nc(F)nc(F)c2Cl)ccc1S(=O)(=O)O] | 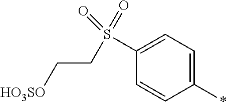 | 6 | 585 |
| 42 | 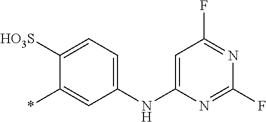 [SMILES: *c1cc(Nc2cc(F)nc(F)n2)ccc1S(=O)(=O)O] | 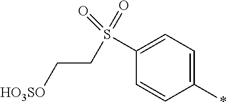 | 6 | 585 |
| 43 | 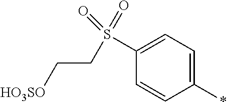 | 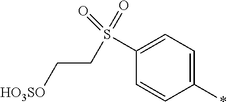 | 5 | 582 |
| 44 | 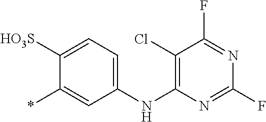 [SMILES: *c1cc(Nc2nc(F)nc(F)c2Cl)ccc1S(=O)(=O)O] | 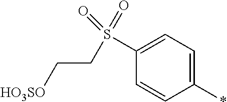 | 5 | 580 |
| 45 | 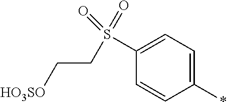 | 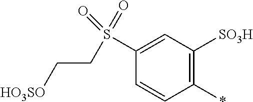 | 6 | 589 |
| 46 | 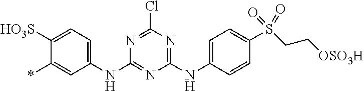 | 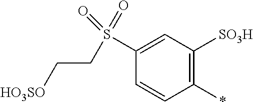 | 6 | 587 |
| 47 | 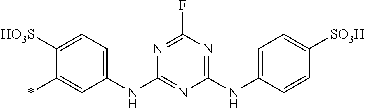 [SMILES: *c1cc(Nc2nc(F)nc(Nc3ccc(S(=O)(=O)O)cc3)n2)ccc1S(=O)(=O)O] | 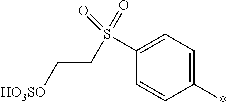 | 6 | 585 |
| 48 | 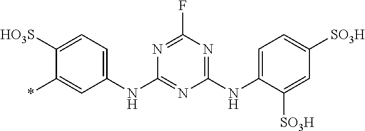 [SMILES: *c1cc(Nc2nc(F)nc(Nc3ccc(S(=O)(=O)O)cc3S(=O)(=O)O)n2)ccc1S(=O)(=O)O] | 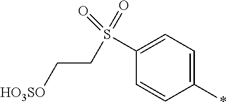 | 6 | 586 |
| 49 | 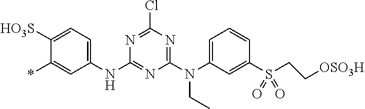 | 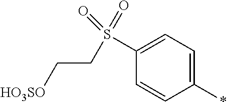 | 6 | 585 |
| 50 | 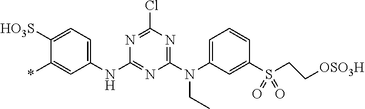 | 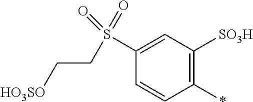 | 6 | 583 |
| 51 | 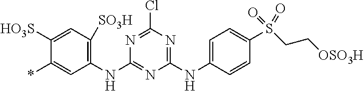 | 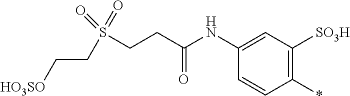 | 6 | 590 |
| 52 | 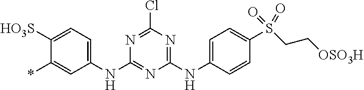 | 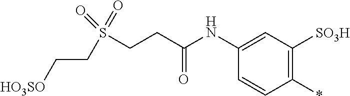 | 6 | 590 |

### Example 53 to 93

Table 3 shows further dyes of formula (III) useful in the dye mixture according to the invention. Exemplarily, the dyes are shown in their free-acid form, but might also be used in their salt form as described in the general part of the present application. The dyes leave red to reddish brown dyeings or prints on cotton revealing good fastness properties. In combination with yellowish compounds of formula (I) and the navy components of formula (II) of the invention these dyestuffs work very well for black mixtures with excellent fastness behaviour.

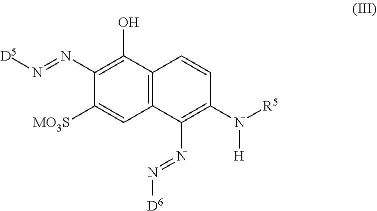

TABLE 3
(*signifies the attachment to the azo-group)

| Ex- | | | | |
|---|---|---|---|---|
| am- | | | | λₘₐₓ |
| ple | D⁵ | D⁶ | R⁵ | [nm] |
| 53 | 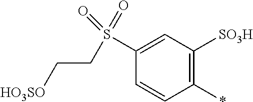 | 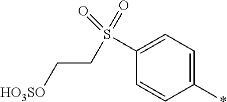 | —CH₃ | 520 |
| 54 | as example 53 | as example 53 | —CH₂CH₃ | 519 |
| 55 | as example 53 | as example 53 | —CH₂CH₂OH | 521 |
| 56 | as example 53 | as example 53 | H | 520 |
| 57 | 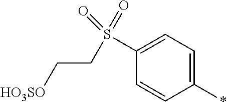 | 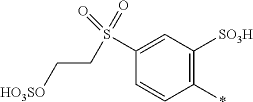 | —CH₃ | 520 |
| 58 | as example 57 | as example 57 | —CH₂CH₃ | 519 |
| 59 | as example 57 | as example 57 | H | 520 |
| 60 | 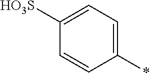 [SMILES: *c1ccc(S(=O)(=O)O)cc1] | as example 57 | H | 518 |
| 61 | 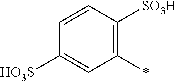 [SMILES: *c1cc(S(=O)(=O)O)ccc1S(=O)(=O)O] | as example 57 | —CH₃ | 516 |
| 62 | 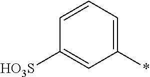 [SMILES: *c1cccc(S(=O)(=O)O)c1] | as example 57 | —CH₂CH₂SO₃H | 517 |
| 63 | 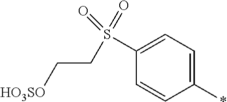 | as example 57 | —CH₂CH₂OH | 521 |
| 64 | 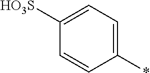 [SMILES: *c1ccc(S(=O)(=O)O)cc1] | as example 57 | —CH₂CH₃ | 519 |
| 65 | 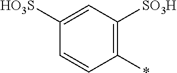 [SMILES: *c1ccc(S(=O)(=O)O)cc1S(=O)(=O)O] | 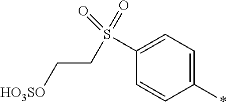 | H | 517 |
| 66 | 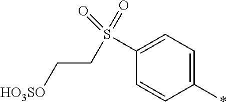 | 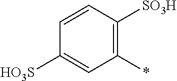 [SMILES: *c1cc(S(=O)(=O)O)ccc1S(=O)(=O)O] | —CH₃ | 517 |
| 67 | 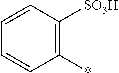 [SMILES: *c1ccccc1S(=O)(=O)O] | 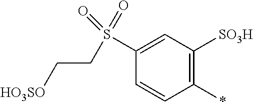 | H | 517 |
| 68 | 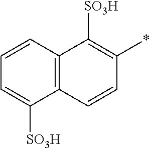 [SMILES: *c1ccc2c(S(=O)(=O)O)cccc2c1S(=O)(=O)O] | as example 67 | H | 519 |
| 69 | 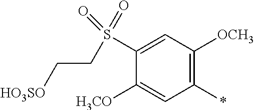 | as example 67 | H | 532 |
| 70 | as example 69 | as example 67 | —CH₃ | 531 |
| 71 | as example 69 | as example 67 | —CH₂CH₂OH | 533 |
| 72 | 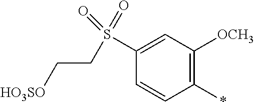 | as example 67 | —CH₃ | 528 |
| 73 | as example 72 | as example 67 | H | 526 |
| 74 | as example 72 | as example 67 | —CH₂CH₃ | 528 |
| 75 | 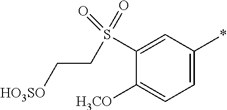 | as example 67 | H | 529 |
| 76 | 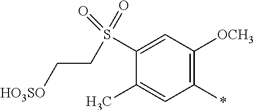 | as example 67 | H | 525 |
| 77 | as example 77 | as example 67 | —CH₃ | 526 |
| 78 | as example 77 | as example 67 | —CH₂CH₂SO₃H | 527 |
| 79 | 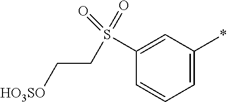 | as example 67 | —CH₃ | 523 |
| 80 | 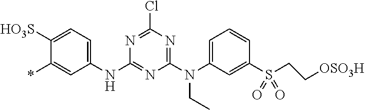 | as example 67 | H | 524 |
| 81 | as example 80 | as example 67 | —CH₃ | 526 |
| 82 | 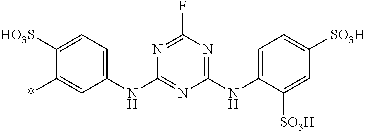 [SMILES: *c1cc(Nc2nc(F)nc(Nc3ccc(S(=O)(=O)O)cc3S(=O)(=O)O)n2)ccc1S(=O)(=O)O] | as example 67 | H | 523 |
| 83 | as example 82 | 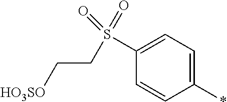 | —CH₃ | 523 |
| 84 | 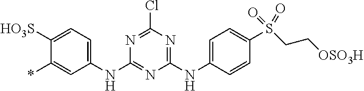 | 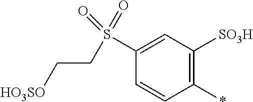 | H | 524 |
| 85 | 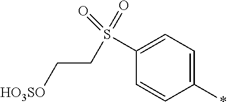 | 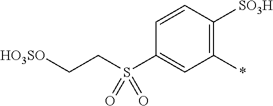 | H | 516 |
| 86 | as example 85 | as example 85 | —CH₂CH₂CN | 518 |
| 87 | as example 85 | 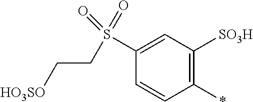 | —CH₂CH₂CH₂CH₃ | 517 |
| 88 | 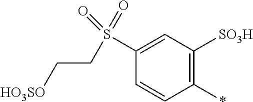 | as example 87 | —CH₂C(CH₃)₂ | 519 |
| 89 | 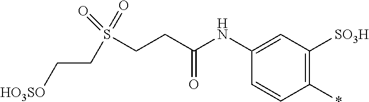 | as example 87 | H | 522 |
| 90 | 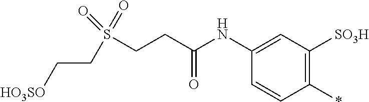 | 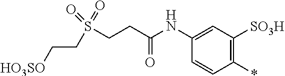 | —CH₃ | 526 |
| 91 | as example 90 | as example 90 | H | 526 |
| 92 | 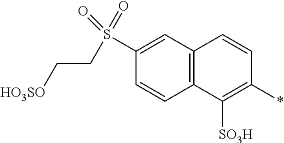 | 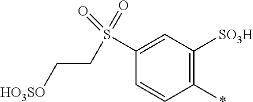 | H | 520 |
| 93 | 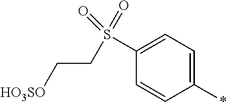 | 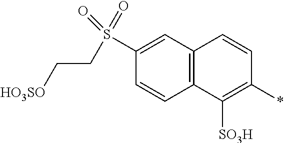 | H | 520 |

### Example 94

50 parts of a dye powder containing a navy disazo dye of formula (1-II)

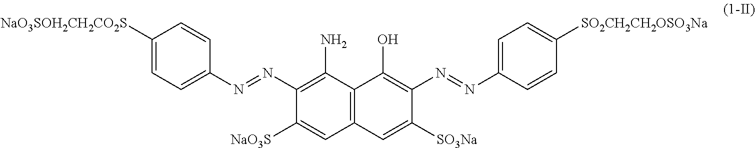

and 30 parts of a dye powder containing a yellowish-brown disazo dye of formula (1-I)

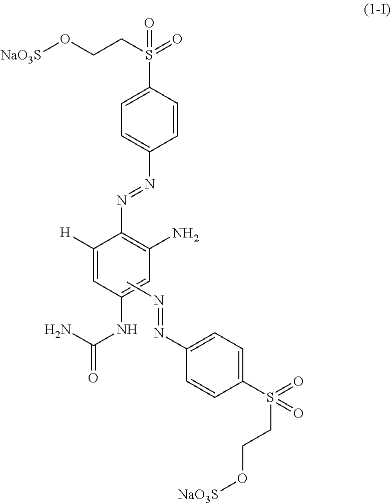

and 11 parts of a dye powder containing a reddish-brown disazo dye of formula (1-III)

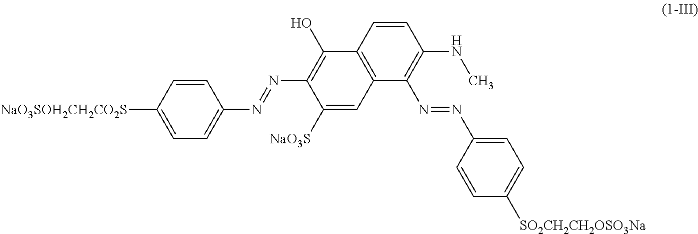

are mixed mechanically with each other. The resulting dye mixture dyes or prints cotton in black shades revealing good fastness properties.

### Example 95

55 parts of a dye powder containing the navy dyestuff of formula (1-II), 33 parts of a dye powder containing the yellow dyestuff of formula (1-I), and 12 parts of a dye powder containing the red dyestuff of example 56 are dissolved in 600 parts of water and the resulting dye solution is adjusted to pH 5-6. Spray drying of this dye solution gives a black powder which leaves under the dyeing conditions typical for reactive dyes, black dyeings or prints on cotton, which show good light fastness and wet fastness properties.

### Examples 96 to 249

Table 4 shows further dye mixtures according to the invention, prepared analogous to example 94. The mixing ratios are expressed in weight percent. The dyes leave black dyeings or prints on cotton revealing good fastness properties.

| | Navy | Yellow | Red | Ratio |
|---|---|---|---|---|
| Example | component | component | component | Navy/Yellow/Red |
| 96 | 1-II | 1-I | 53 | 50/37/13 |
| 97 | 1-II | 1-I | 59 | 59/35/6 |
| 98 | 1-II | 1-I | 76 | 60/30/10 |
| 99 | 1-II | 1-I | 77 | 55/33/12 |
| 100 | 1-II | 1-I | 2-III | 55/33/12 |
| 101 | 1-II | 1-I | 73 | 53/35/12 |
| 102 | 1-II | 1-I | 72 | 54/31/15 |
| 103 | 1-II | 1-I | 80 | 56/35/9 |
| 104 | 1-II | 1-I | 84 | 53/37/10 |
| 105 | 1-II | 3 | 56 | 53/36/11 |
| 106 | 1-II | 3 | 69 | 55/33/12 |
| 107 | 1-II | 3 | 63 | 55/33/12 |
| 108 | 1-II | 3 | 59 | 55/33/12 |
| 109 | 1-II | 3 | 73 | 50/36/14 |
| 110 | 1-II | 3 | 2-III | 54/31/15 |
| 111 | 1-II | 3 | 77 | 56/35/9 |
| 112 | 1-II | 4 | 56 | 53/37/10 |
| 113 | 1-II | 4 | 53 | 55/31/14 |
| 114 | 1-II | 4 | 59 | 55/33/12 |
| 115 | 1-II | 4 | 76 | 55/33/12 |
| 116 | 1-II | 4 | 77 | 55/33/12 |
| 117 | 1-II | 4 | 69 | 55/33/12 |
| 118 | 1-II | 4 | 73 | 48/39/13 |
| 119 | 1-II | 4 | 72 | 53/32/15 |
| 120 | 1-II | 4 | 80 | 54/31/15 |
| 121 | 1-II | 5 | 56 | 55/33/12 |
| 122 | 1-II | 5 | 53 | 56/31/13 |
| 123 | 1-II | 5 | 59 | 56/31/13 |
| 124 | 1-II | 5 | 76 | 56/31/13 |
| 125 | 1-II | 5 | 77 | 54/31/15 |
| 126 | 1-II | 7 | 69 | 56/35/9 |
| 127 | 1-II | 7 | 77 | 53/37/10 |
| 128 | 1-II | 7 | 75 | 54/31/15 |
| 129 | 1-II | 7 | 87 | 54/31/15 |
| 130 | 1-II | 7 | 89 | 54/31/15 |
| 131 | 1-II | 7 | 81 | 57/32/11 |
| 132 | 1-II | 7 | 53 | 53/31/16 |
| 133 | 1-II | 9 | 56 | 58/32/10 |
| 134 | 1-II | 9 | 53 | 58/32/10 |
| 135 | 1-II | 10 | 54 | 58/32/10 |
| 136 | 1-II | 9 | 86 | 55/33/12 |
| 137 | 1-II | 11 | 79 | 55/33/12 |
| 138 | 1-II | 11 | 74 | 55/33/12 |
| 139 | 1-II | 11 | 75 | 55/33/12 |
| 140 | 1-II | 11 | 76 | 55/33/12 |
| 141 | 1-II | 11 | 56 | 54/31/15 |
| 142 | 1-II | 15 | 53 | 50/37/13 |
| 143 | 1-II | 15 | 59 | 59/34/7 |
| 144 | 1-II | 15 | 76 | 60/30/10 |
| 145 | 1-II | 23 | 77 | 55/33/12 |
| 146 | 1-II | 23 | 69 | 55/33/12 |
| 147 | 1-II | 23 | 73 | 53/35/12 |
| 148 | 1-II | 24 | 72 | 54/31/15 |
| 149 | 27 | 3 | 2-III | 56/35/9 |
| 150 | 27 | 3 | 53 | 53/37/10 |
| 151 | 27 | 4 | 53 | 54/31/15 |
| 152 | 27 | 4 | 56 | 54/31/15 |
| 153 | 27 | 5 | 76 | 55/33/12 |
| 154 | 27 | 7 | 76 | 55/33/12 |
| 155 | 27 | 9 | 76 | 55/33/12 |
| 156 | 27 | 10 | 53 | 55/33/12 |
| 157 | 27 | 11 | 69 | 55/33/12 |
| 158 | 27 | 22 | 70 | 53/37/10 |
| 159 | 28 | 4 | 76 | 54/31/15 |
| 160 | 28 | 3 | 2-III | 54/31/15 |
| 161 | 28 | 7 | 53 | 54/31/15 |
| 162 | 28 | 6 | 56 | 57/32/11 |
| 163 | 28 | 41 | 63 | 53/31/16 |
| 164 | 28 | 45 | 59 | 58/32/10 |
| 165 | 28 | 51 | 73 | 58/32/10 |
| 166 | 28 | 36 | 2-III | 53/35/12 |
| 167 | 28 | 37 | 77 | 54/31/15 |
| 168 | 28 | 3 | 56 | 56/35/9 |
| 169 | 30 | 3 | 53 | 53/37/10 |
| 170 | 30 | 4 | 59 | 55/33/12 |
| 171 | 30 | 4 | 76 | 55/33/12 |
| 172 | 30 | 5 | 77 | 53/35/12 |
| 173 | 30 | 7 | 69 | 54/31/15 |
| 174 | 30 | 8 | 2-III | 56/34/10 |
| 175 | 30 | 10 | 72 | 53/37/10 |
| 176 | 30 | 4 | 80 | 54/31/15 |
| 177 | 30 | 5 | 56 | 54/31/15 |
| 178 | 30 | 7 | 53 | 53/37/10 |
| 179 | 32 | 9 | 59 | 54/31/15 |
| 180 | 32 | 10 | 76 | 54/31/15 |
| 181 | 32 | 11 | 77 | 55/33/12 |
| 182 | 32 | 22 | 69 | 55/33/12 |
| 183 | 32 | 4 | 77 | 54/31/15 |
| 184 | 32 | 3 | 56 | 53/37/10 |
| 185 | 32 | 7 | 53 | 54/31/15 |
| 186 | 35 | 11 | 60 | 54/31/15 |
| 187 | 35 | 15 | 76 | 54/31/15 |
| 188 | 35 | 23 | 77 | 57/32/11 |
| 189 | 35 | 22 | 2-III | 53/31/16 |
| 190 | 35 | 45 | 73 | 58/32/10 |
| 191 | 35 | 51 | 72 | 58/32/10 |
| 192 | 36 | 36 | 80 | 54/31/15 |
| 193 | 36 | 37 | 84 | 55/33/12 |
| 194 | 36 | 3 | 56 | 55/33/12 |
| 195 | 36 | 6 | 69 | 55/33/12 |
| 196 | 36 | 4 | 62 | 55/33/12 |
| 197 | 36 | 4 | 59 | 55/33/12 |
| 198 | 36 | 5 | 73 | 53/35/12 |
| 199 | 36 | 7 | 2-III | 54/31/15 |
| 200 | 36 | 8 | 77 | 54/31/15 |
| 201 | 38 | 11 | 76 | 55/33/12 |
| 202 | 38 | 4 | 56 | 54/31/15 |
| 203 | 38 | 5 | 53 | 55/33/12 |
| 204 | 38 | 8 | 59 | 53/35/12 |
| 205 | 38 | 9 | 76 | 54/31/15 |
| 206 | 38 | 10 | 74 | 55/33/12 |
| 207 | 38 | 11 | 69 | 55/33/12 |
| 208 | 39 | 24 | 2-III | 55/33/12 |
| 209 | 39 | 4 | 72 | 53/37/10 |
| 210 | 39 | 3 | 80 | 54/31/15 |
| 211 | 39 | 9 | 56 | 54/31/15 |
| 212 | 39 | 11 | 53 | 54/31/15 |
| 213 | 39 | 3 | 60 | 57/32/11 |
| 214 | 42 | 3 | 76 | 53/31/16 |
| 215 | 42 | 3 | 77 | 54/31/15 |
| 216 | 42 | 3 | 69 | 57/32/11 |
| 217 | 42 | 4 | 77 | 55/33/12 |
| 218 | 42 | 4 | 56 | 55/33/12 |
| 219 | 42 | 5 | 53 | 53/35/12 |
| 220 | 42 | 7 | 59 | 54/31/15 |
| 221 | 42 | 8 | 76 | 55/33/12 |
| 222 | 42 | 10 | 77 | 55/33/12 |
| 223 | 43 | 4 | 69 | 54/31/15 |
| 224 | 43 | 5 | 2-III | 53/37/10 |
| 225 | 43 | 7 | 72 | 54/31/15 |
| 226 | 43 | 9 | 80 | 54/31/15 |
| 227 | 46 | 10 | 56 | 54/31/15 |
| 228 | 46 | 11 | 63 | 57/32/11 |
| 229 | 46 | 22 | 59 | 53/31/16 |
| 230 | 46 | 4 | 76 | 54/31/15 |
| 231 | 46 | 3 | 77 | 57/32/11 |
| 232 | 46 | 45 | 69 | 55/33/12 |
| 233 | 47 | 51 | 77 | 55/33/12 |
| 234 | 47 | 36 | 56 | 55/33/12 |
| 235 | 47 | 37 | 54 | 55/33/12 |
| 236 | 47 | 3 | 59 | 53/35/12 |
| 237 | 47 | 3 | 76 | 54/31/15 |
| 238 | 47 | 4 | 77 | 54/31/15 |
| 239 | 47 | 4 | 68 | 54/31/15 |
| 240 | 47 | 5 | 2-III | 54/31/15 |
| 241 | 47 | 7 | 72 | 54/31/15 |
| 242 | 52 | 8 | 80 | 57/32/11 |
| 243 | 52 | 10 | 56 | 53/37/10 |
| 244 | 52 | 4 | 53 | 54/31/15 |
| 245 | 52 | 5 | 59 | 54/31/15 |
| 246 | 52 | 7 | 75 | 54/31/15 |
| 247 | 52 | 9 | 77 | 57/32/11 |
| 248 | 52 | 10 | 69 | 53/31/16 |
| 249 | 52 | 11 | 70 | 55/33/12 |
| 250 | 1-II | 1-I | — | 70/30/0 |
| 251 | 1-II | 3 | — | 68/32/0 |
| 252 | 1-II | 4 | — | 73/27/0 |
| 253 | 1-II | 9 | — | 75/25/0 |
| 254 | 1-II | 6 | — | 67/33/0 |
| 255 | 1-II | 23 | — | 62/38/0 |
| 256 | 1-II | 24 | — | 70/30/0 |
| 257 | 27 | 1-I | — | 70/30/0 |
| 258 | 27 | 3 | — | 70/30/0 |
| 259 | 27 | 9 | — | 66/34/0 |
| 260 | 28 | 1-I | — | 69/31/0 |
| 261 | 28 | 3 | — | 72/28/0 |
| 262 | 28 | 6 | — | 71/29/0 |
| 263 | 31 | 1-I | — | 70/30/0 |
| 264 | 31 | 3 | — | 73/27/0 |

### Application Example A

0.3 parts of the dye mixture of Example 1 is dissolved in 100 parts of demineralised water and 8 parts of Glauber's salt (calcined) are added to produce a dye bath. The dyebath is heated to 50° C., then 10 parts of cotton fabric (bleached) are added. During the addition of sodium carbonate the temperature is kept at 50° C. Subsequently, the dye bath is heated to 60° C., and dyeing is effected for another hour at 60° C.

The dyed fabric is then rinsed with running cold water for 3 minutes and afterwards with running hot water for a further 3 minutes. The dyeing is washed at boiling temperature for 15 minutes in 500 parts of demineralised water in the presence of 0.25 parts of Marseille soaps. After being rinsed with running hot water for 3 minutes and centrifuged, the dyed fabric is dried in a cabinet dryer at about 70° C. A black cotton dyeing is obtained showing good fastness properties, in particularly good light and wet/washing fastness properties, which is stable towards oxidative influences.

### Application Example B

A printing paste comprising

| | |
|---|---|
| 40 | parts of the dye mixture of Example 1 |
| 100 | parts of urea |
| 350 | parts of water |
| 500 | parts of a 4% sodium alginate thickener and |
| 10 | parts of sodium bicarbonate |
| 1000 | parts in total |

is applied to cotton fabric in accordance with conventional printing methods.

The printed fabric is dried and fixed in steam at 102° C. to 104° C. for 4 to 8 minutes. It is rinsed in cold and then hot water, washed at the boil (according to the method described in Application Example A) and dried. A yellowish brown print is obtained which has good general fastness properties.

Similarly, the dye mixtures of Examples 2 to 40 or mixtures of the exemplified dyestuffs may be employed to print cotton in accordance with the method given in Application Example C. All prints obtained are black and show good fastness properties, in particular good light fastness properties.

### Application Example C

70 parts of chemically bleached sulfite cellulose of pinewood and 30 parts of chemically bleached sulfite cellulose of birchwood are grounded in a Hollander in 2000 parts of water. 0.2 Parts of the dye mixture of Example 1 are sprinkled into this pulp. After mixing for 20 minutes, paper is produced therefrom. The absorbent paper obtained in this way is dyed black. The waste water is colourless.

### Application Example D

0.5 parts of the dye mixture of Example 1 are dissolved in 100 parts of hot water and cooled to room temperature. The solution is added to 100 parts of chemically bleached sulfite cellulose, which have been grounded in a Hollander with 2000 parts of water. After thorough mixing for 15 minutes, sizing takes place in the usual way with rosin size and aluminium sulfate. Paper which is produced from this material has a black shade and has good waste-water and wet/washing fastness, as well as good light fastness.

### Application Example E

An absorbent length of unsized paper is drawn through a dye mixture of the following composition at 40-50° C.:

| | |
|---|---|
| 0.5 | parts of the dye mixture of Example 1 |
| 0.5 | parts of starch and |
| 99.0 | parts of water. |

The excess dye mixture is squeezed out through two rollers. The dried length of paper is dyed black.

Dyeing may also take place in a similar manner to that of Examples D to F using the dye mixture of Examples 2 to 40, or a dye preparation thereof. The paper dyeings obtained are black and have a high level of fastness.

### Application Example F

50 parts of bleached pinewood sulfite cellulose and 50 parts of bleached beech cellulose (degree of beating 30° SR (Schopper Riegler degree)) are mixed with 0.5 parts of the dye mixture of Example 1 in water (pH 4, water hardness 10° dH). After 16 minutes, sheet formation takes place. The paper is dyed in an intense black shade. In contrast, a dyeing made at pH 7 shows no variation in depth or shade.

### Application Example H

100 parts of cotton tricot, which have been dyed with the dye mixture of Example 1 analogously to the method of Example H in ca. 1/1 standard depth, are mixed without intermediate drying in 1000 parts of tap water at 25° C. with 5 parts of sodium chloride and 4 parts of an after-treatment agent obtained from the reaction of diethylenetriamine with dicyandiamide. The pH value of the dye bath is set at 6.5 to 7. The bath is heated to 60° C. over the course of 20 minutes, and this temperature is maintained for a further 20 minutes. Afterwards, the material is rinsed with cold tap water. The black cotton dyeing which has been after-treated in this way has perfect washing fastness and very good light fastness.

### Application Example I

A cotton dyeing produced with the dye mixture of Example 1 analogously to the method of Example H in 1/1 standard depth, is impregnated on a padder with a solution, which contains 100 g/I of an after-treatment agent obtained by reacting the after-treatment agent of Example I with dimethyloldihydroxyethyleneurea and a hardening catalyst, and it is squeezed out to a pick-up of ca. 80%. It is subsequently shock-dried for 45 seconds on a stenter at a temperature of 175 to 180° C. The black cotton dyeing thus obtained is notable for its perfect washing fastness. At the same time, there is a considerable improvement in the creasing fastness, and reduced swelling value of the cellulosic fibers.

### Application Example J

2.5 parts of the dye mixture obtained in Example 1 are dissolved with stirring at 25° C. in a mixture of 20 parts diethyleneglycol and 77.5 parts water to obtain a printing ink suitable for inkjet printing.

1. Dye mixture comprising at least one compound of the general formula (I) or a salt thereof 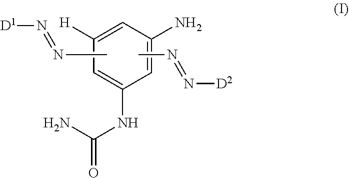
wherein
D¹ and D² are independently from each other unsubstituted or substituted aryl, and
at least one compound of the general formula (II) or a salt thereof 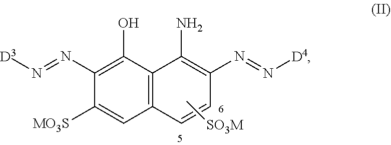
wherein
M is independently selected from —H, an alkali metal cation, an alkaline earth metal cation, an organic ammonium cation or a mixture thereof,
and optionally at least one compound of the general formula (III) or a salt thereof 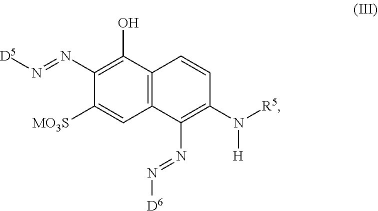
wherein
M is independently selected from —H, an alkali metal cation, an alkaline earth metal cation, an organic ammonium cation or a mixture thereof, and wherein M as defined in formula (III) is identical or different to M as defined in formula (II),
R⁵ is —H or unsubstituted or substituted, linear or branched C₁₋₈ alkyl,
D³, D⁴, D⁵ and D⁶ are independently from each other a residue of the general formula (IV) or a salt thereof 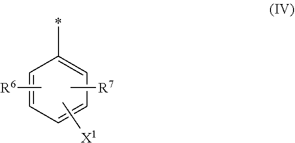
wherein
R⁶ and R⁷ are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, -C(O)NH₂ or —NH—C(O)—NH₂, wherein M is independently selected from —H, an alkali metal cation, an alkaline earth metal cation, an organic ammonium cation or a mixture thereof and wherein M as defined in formula (IV) is identical or different to M as defined in formula (II) or (III),
X¹ is —H or a radical of the general formula —SO₂Y¹, wherein
Y¹ is —OH, —CH═CH₂ or —CH₂CH₂—Z, wherein
Z is —OH or a leaving group which can be eliminated under the action of alkali,
* signifies the attachment to the azo group of formula (II) and/or (III)
and/or
D³, D⁴, D⁵ and D⁶ are independently from each other a residue of the general formula (V) or a salt thereof 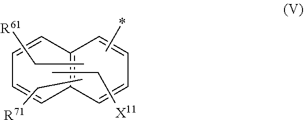
wherein
R⁶¹ and R⁷¹ are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein M is independently selected from —H, an alkali metal cation, an alkaline earth metal cation, an organic ammonium cation or a mixture thereof, and wherein M as defined in formula (V) is identical or different to M as defined in formula (II), (III) or (IV),
X¹¹ is —H or a radical of the general formula —SO₂Y¹, wherein
Y¹ is —OH, —CH═CH₂ or —CH₂CH₂—Z, wherein
Z is —OH or a leaving group which can be eliminated under the action of alkali;
* signifies the attachment to the azo group of formula (II) and/or (III)
and/or
D³, D⁴, D⁵ and D⁶ are independently from each other a residue of the general formula (VI) or a salt thereof 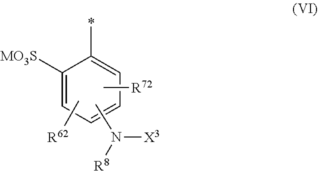
wherein
R⁶² and R⁷² are independently from each other —H, halogen, unsubstituted or substituted, linear or branched C₁₋₆ alkyl, unsubstituted or substituted, linear or branched C₁₋₆ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein M is independently selected from —H, an alkali metal cation, an alkaline earth metal cation, an organic ammonium cation or a mixture thereof, and wherein M as defined in formula (VI) is identical or different to M as defined in formula (II), (III), (IV) or (V),
R⁸ is —H, unsubstituted or substituted, linear or branched C₁₋₆ alkyl or unsubstituted phenyl or substituted phenyl; and
* signifies the attachment to the azo group of formula (II) and/or (III)
X³ is a radical of the general formula (VII), (VIII) or (IX) 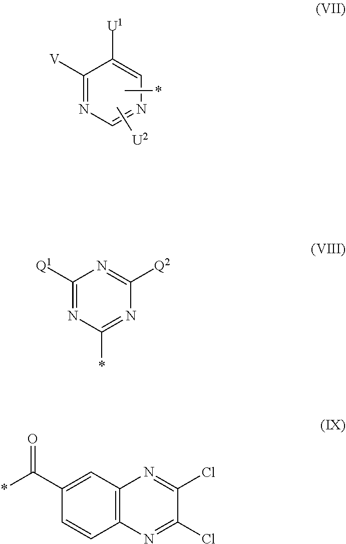
wherein
* signifies the attachment to the amino group of formula (VI)
V is —F or —Cl;
U¹ and U² are independently from each other —F, —Cl or —H;
Q¹ and Q² are independently from each other —F, —Cl, —NHCN, —OH, unsubstituted or substituted, linear or branched C₁₋₆ alkoxy, phenoxy, mercapto, unsubstituted or substituted, linear or branched C₁₋₆ alkylmercapto, pyridine, carboxypyridino, carbamoylpyridino or a radical of the general formula (X) or (XI) 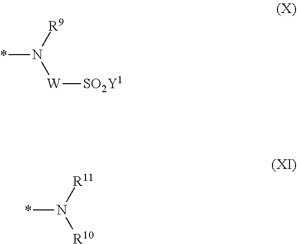
wherein
* signifies the attachment to formula (VIII),
R⁹ is —H, unsubstituted or substituted, linear or branched C₁₋₆ alkyl, linear or branched sulfo-(C₁₋₆)-alkyl or unsubstituted phenyl or substituted phenyl,
R¹⁰ and R¹¹ are independently from each other R⁹ or form together a cyclic ring of the formula —(CH₂)ₙ— with n being 4 or 5 or —(CH₂)₂-E-(CH₂)₂—, wherein E is O, S, SO₂ or NR¹² and R¹² is unsubstituted or substituted, linear or branched C₁₋₆ alkyl,
W is unsubstituted or substituted phenylen, C₁₋₄-alkylene-arylene, C₂₋₆ alkylene, C₂₋₆ alkylene being interrupted by —O—, —S—, SO₂—, —NH—, —CO— and —C(O)NH—; unsubstituted or substituted phenylene-C(O)NH-phenylene or unsubstituted or substituted naphthylene,
Y¹ is —OH, —CH═CH₂ or —CH₂CH₂—Z, wherein
Z is —OH or a leaving group which can be eliminated under the action of alkali.

2. Dye mixture according to claim 1, wherein the dye mixture comprises the following components (a), (b) and (c), wherein
(a) is from 1 to 60 parts of at least one compound of formula (I) or a salt thereof,
(b) is from 20 to 99 parts of at least one compound of formula (II) or a salt thereof, and
(c) is from 0.0 to 60 parts of at least one compound of formula (III) or a salt thereof,
wherein all parts are by weight and the number of parts of components (a), (b) and (c) amounts to 100.

3. Dye mixture according to claim 1, wherein the substituents of the substituted aryl D¹ and D² of structural formula (I) are selected independently from each other from the group of —H, —SO₃M, unsubstituted or substituted, linear or branched C₁₋₆ alkyl, unsubstituted or substituted, linear or branched C₁₋₆ alkoxy or —SO₂Y, wherein Y is —OH, —CH═CH₂ or —CH₂CH₂—Z, wherein Z is —OH or a leaving group which can be eliminated under the action of alkali, and wherein M is independently selected from —H, an alkali metal cation, an alkaline earth metal cation, an organic ammonium cation or a mixture thereof, and wherein M as defined in formula (I) is identical or different to M as defined in formula (II), (III), (IV), (V) or (VI).

4. Dye mixture according to claim 3, wherein the substituents of the substituted alkyl and alkoxy groups are selected independently from each other from the group consisting of halogen, —CN, —NH₂ or —COOM, M is independently selected from —H, an alkali metal cation, an alkaline earth metal cation, an organic ammonium cation or a mixture thereof, and wherein M as defined in formula (I) is identical or different to M as defined in formula (II), (III), (IV), (V) or (VI).

5. Dye mixture according to claim 1, wherein
D¹ is 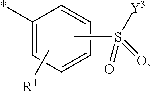
and
D² is 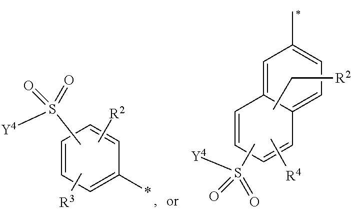
R¹ and R² are independently from each other —H, —SO₃M, unsubstituted or substituted, linear or branched C₁₋₆ alkyl or unsubstituted or substituted, linear or branched C₁₋₆ alkoxy,
R³ is —H, unsubstituted or substituted, linear or branched C₁₋₆ alkyl or unsubstituted or substituted, linear or branched C₁₋₆ alkoxy,
R⁴ is —H or —SO₃M, wherein
M is independently selected from —H, an alkali metal cation, an alkaline earth metal cation, an organic ammonium cation or a mixture thereof, and wherein M as defined in formula (I) is identical or different to M as defined in formula (II), (III), (IV), (V) or (VI),
Y³ and Y⁴ are independently from each other —OH, —CH═CH₂ or —CH₂CH₂—Z, wherein Z is —OH or a leaving group which can be eliminated under the action of alkali, and
* signifies the attachment to the azo group of formula (I).

6. Dye mixture according to claim 1, wherein
D¹ is 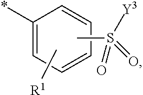
and
D² is 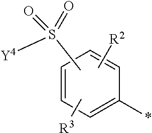
R¹ and R² are independently from each other —H, —SO₃M, unsubstituted or substituted C₁₋₂ alkyl or unsubstituted or substituted C₁₋₂ alkoxy, wherein
M is independently selected from —H, an alkali metal cation, an alkaline earth metal cation, an organic ammonium cation or a mixture thereof, and wherein M as defined in formula (I) is identical or different to M as defined in formula (II), (III), (IV), (V) or (VI),
R³ is —H, methyl or methoxy, particularly —H,
Y³ and Y⁴ are independently from each other —OH, —CH═CH₂ or —CH₂CH₂—Z, wherein Z is —Cl or —OSO₃H, and
* signifies the attachment to the azo group of formula (I).

7. Dye mixture according to claim 1, wherein
D¹ is 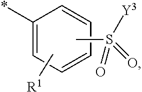
and
D² is 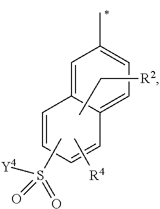
R¹ and R² are independently from each other —H, —SO₃M, unsubstituted or substituted C₁₋₂ alkyl or unsubstituted or substituted C₁₋₂ alkoxy,
R⁴ is —H or —SO₃M,
M is independently selected from —H, an alkali metal cation, an alkaline earth metal cation, an organic ammonium cation or a mixture thereof, and wherein M as defined in formula (I) is identical or different to M as defined in formula (II), (III), (IV), (V) or (VI)
Y³ and Y⁴ are independently from each other —OH, —CH═CH₂ or —CH₂CH₂—Z, wherein Z is —Cl or —OSO₃H, and
* signifies the attachment to the azo group of formula (I).

8. Dye mixture according to claim 1, wherein
D³, D⁴, D⁵ and D⁶ are independently from each other a residue of the general formula (IV) or a salt thereof 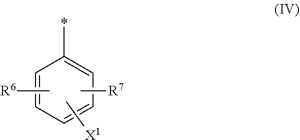
wherein
R⁶ and R⁷ are independently from each other —H, halogen, unsubstituted or substituted, linear or branched C₁₋₆ alkyl, unsubstituted or substituted, linear or branched C₁₋₄ alkoxy, unsubstituted or substituted, linear or branched C₁₋₄ carbamido, —OH, —SO₃M, —SO₂NH₂, —COOM, —CN, —NO₂, —C(O)NH₂ or —NH—C(O)—NH₂, wherein
M is independently selected from —H, an alkali metal cation, an alkaline earth metal cation, an organic ammonium cation or a mixture thereof, and wherein M as defined in formula (IV) is identical or different to M as defined in formula (I), (II), (III), (V) or (VI),
X¹ is —H or a radical of the general formula —SO₂Y¹, wherein
Y¹ is —OH, —CH═CH₂ or —CH₂CH₂—Z, wherein
Z is —OH or a leaving group which can be eliminated under the action of alkali.

9. Dye mixture according to claim 8, wherein Y¹ is —CH₂CH₂—Z, wherein Z is —Cl or —OSO₃H.

10. Dye mixture according to claim 8, wherein R⁶ and R⁷ are independently from each other —H, —SO₃M, unsubstituted or substituted C₁₋₆ alkyl or unsubstituted or substituted C₁₋₆ alkoxy, wherein is M is independently selected from —H, an alkali metal cation, an alkaline earth metal cation, an organic ammonium cation or a mixture thereof, and wherein M as defined in formula (IV) is identical or different to M as defined in formula (I), (II), (III), (V) or (VI).

11. Composition comprising the dye mixture according to claim 1, wherein the composition comprises components (d) and (e), wherein
(d) is from 0.01 to 30 parts of the dye mixture as defined in claim 1; and
(e) is from 70 to 99.99 parts of water or a medium comprising a mixture of water and an organic solvent, or an organic solvent free from water, or a low melting point solid,
wherein all parts are by weight and the number of parts of components (d)+(e) amounts to 100.

12. Ink or printing ink or inkjet printing ink or printing paste or dyeing bath for printing or dyeing a substrate comprising the dye mixture as defined in claim 1.

13. Use of the dye mixture as defined in claim 1 for dyeing and/or printing substrates.

14. Process for dyeing or printing a substrate with a dye mixture according to claim 1.

15. Substrate comprising the dye mixture according to claim 1.

16. Composition according to claim 11 wherein component (d) is from 0.1 to 20 parts, or from 0.5 to 15 parts, or from 1 to 5 parts of the dye mixture and wherein component (e) is from 80 to 99.9 parts, or from 85 to 99.5 parts, or from 95 to 99 parts of water or a medium comprising a mixture of water and an organic solvent, or an organic solvent free from water, or a low melting point solid.

17. Ink or printing ink or inkjet printing ink or printing paste or dyeing bath for printing or dyeing a substrate comprising the composition as defined in claim 11.

18. Use of the composition as defined in claim 11 for dyeing and/or printing substrates.

19. Process for dyeing or printing a substrate with the composition as defined in claim 11.

20. Substrate comprising the dye mixture according to the composition as defined in claim 11.
